(19) United States
(12) Patent Application Publication
(10) Pub. No.: US 2025/0380095 A1
(43) Pub. Date: Dec. 11, 2025

(54) HEARING AID

(71) Applicant: Oticon A/S, Smørum (DK)

(72) Inventors: Jais Andreas Breusch ANGEL, Smørum (DK); Morten FUGLSANG-PHILIP, Smørum (DK); Nicolai Alexander CLAUSEN, Smørum (DK)

(21) Appl. No.: 19/208,619

(22) Filed: May 15, 2025

(30) Foreign Application Priority Data
Jun. 7, 2024 (EP) 24180678.5

(51) Int. Cl. H04R 25/00

(52) U.S. Cl. CPC H04R 25/603; H04R 25/658; H04R 2225/0216; H04R 2225/61

(57) ABSTRACT

Disclosed herein are embodiments of a hearing aid having a housing defining an interior and exterior of a hearing aid. The hearing aid further includes a switch and a switch actuator mounted on the housing at an aperture. The housing further includes a barrier extending across the aperture and secured in the housing at an internal surface. The barrier can include a membrane.

### CROSS REFERENCE TO RELATED APPLICATIONS

Any and all application for which a foreign or domestic priority claim is identified in the Application Data Sheet as filed with the present application are hereby incorporated by reference under 37 CFR 1.57.

### TECHNICAL FIELD

The present disclosure relates to the field of hearing aids. In particular, the present disclosure relates to improvements relating to a hearing aid housing. More particularly, the present disclosure relates to improved sealing arrangements at a hearing aid housing. The present disclosure also relates to improved arrangements for user-operated switching actuators at a hearing aid housing. Still more particularly, the present disclosure relates to improved sealing arrangements at a hearing aid housing in connection with switching actuators. In some aspects, the present disclosure relates to a fabrication method in connection with the above.

### BACKGROUND

In the present context, a hearing aid, e.g. a hearing instrument, refers to a device, which is adapted to improve, augment and/or protect the hearing capability of a user by receiving acoustic signals from the user's surroundings, generating corresponding audio signals, possibly modifying the audio signals and providing the modified audio signals as audible signals to at least one of the user's ears. Such audible signals may e.g. be provided in the form of acoustic signals radiated into the user's outer ears, and/or acoustic signals transferred as mechanical vibrations to the user's inner ears through the bone structure of the user's head and/or through parts of the middle ear.

To achieve its purpose, the hearing aid generally comprises an input unit, a signal processor including an amplifier, a signal output unit and a power supply. The input unit may generate an electric input signal representing sound. The input unit may comprise an input transducer, e.g. a microphone, for converting an external sound such as ambient sound or an external audio signal into an electric input signal. An additional or alternative input unit may comprise a wireless receiver such as a telecoil or other antenna for receiving a wireless audio signal, e.g. in the form of a direct audio input (DAI) from an extrinsic device. An electric input signal derived from a microphone, or DAI or such like, may be fed to processing circuitry for providing a processed, especially a modified or improved acoustic signal to a user. Such modifications may typically include one or more of filtering, amplification, or noise reduction or other enhancements/transformations. The hearing aid will generally also comprise an output unit for providing a stimulus perceived by the user as an acoustic signal based on a processed electric input signal. An output unit may comprise an output transducer such as a receiver (a.k.a. loudspeaker) for providing the stimulus as an acoustic signal to the user. An output unit may alternatively be a vibrator of a bone conduction hearing aid. Such an output transducer may comprise a vibrator for providing the stimulus as mechanical vibration of a skull bone to the user. An output unit may additionally or alternatively comprise a (e.g. wireless) transmitter for transmitting a signal to another device, e.g. a far-end communication partner, e.g. via a network, such as in a telephone mode of operation. The transmitted signal may be any signal; it may for example include a sound signal picked up-by the hearing aid input device(s).

A hearing aid generally comprises an external housing. The housing typically encloses many components such as operative components, including but not limited to e.g.: one or more acoustic microphones; one or more input antenna; signal processing circuitry including elements such as band filters and/or amplifiers; one or more output device such as an acoustic transducer (speaker) or vibrator, or electrical connections to such; a local power supply such as one or more replaceable or rechargeable batteries. In some cases, additional sensors of various types and/or interconnectors, whether for physical or wireless interconnectivity, may be incorporated in a hearing aid housing. A signal processor or amplifier may in particular be a digital signal processor or amplifier. Signal processing circuitry may comprise analogue-to-digital and/or digital-to-analogue conversion modules. Hearing aids may include further elements, depending on desired functionality or modes of functioning. For example, in some cases, an output device may be or may include a vibrating transducer associated with a bone conduction type hearing aid. In many cases, a hearing aid housing may enclose one or more chassis on which multiple operative, i.e. functional, components and/or circuitry-including any or all, or more, of the above—may be arranged. A chassis may typically be assembled into a hearing aid housing by fixing it to a support surface such as a shoulder or groove or fitting of some kind at one or more region of the housing.

One or more switches for actuation by a user may additionally be provided within a hearing aid housing. These may be control switches of various types e.g. associated with operational adjustment such as output signal volume control, or associated with hearing aid functionality such as selecting modes of operation or enabling/disabling and/or selecting interconnectivity with an auxiliary device. Switches may provide any relevant control, adjustment or functional selection. In many cases, these switches may be provided on a chassis in association with hearing aid circuitry such as signal processing circuitry or control circuitry. These switches may be associated with one or more actuators—sometimes known as buttons or control buttons—for operation of associated switches by a user. Such actuators may typically be supported in or on a hearing aid housing. In some cases, an actuator may be supported directly on a chassis, mounted in combination with a switch with which it is associated. One or more actuators may be provided at, on, or within a corresponding aperture at a hearing aid housing. A hearing aid housing may often comprise a rigid shell. For example, a shell may in some cases be painted on its outside surface. A hearing aid housing may be formed primarily by a first housing segment connectable to a second housing segment. Additional housing segments may be provided, as required based on particular hearing aid types or designs. For example, additional housing segments may be provided in the form of openable hatches, for example for closing a battery recess inside the housing. A hearing aid housing segment e.g. a first, second or third segment thereof, may include a shell, which may be referred to as a shell layer. A hearing aid housing may further comprise one or more housing segment which is moulded according to a specific user, especially according to a user's ear or ear canal. Such a moulded housing may in particular be moulded according to a specific user, i.e. to an individual user.

A hearing aid is thus a sophisticated audio-electronic device providing an important sensory support for a user. As such, many of the components housed in a hearing aid are also very sensitive. These may be damaged, contaminated and/or functionally impaired if the hearing aid is subjected to shock and/or an environment characterised by high humidity, dirt or other contaminants. To improve resistance to humidity or dirt, in many instances internal components have been known to be treated with water-repellent agents, e.g. by coating.

The present disclosure addresses improvements to hearing aids, notably in connection with the housing, switch actuators and/or in connection with the need to protect internal components from the external environment or against ingress of moisture or contaminants. Aspects of this disclosure in particular contribute to the protection of internal components.

### SUMMARY

In one aspect, there is provided a hearing aid comprising a housing defining an interior and an exterior in relation to the hearing aid. The housing internally encloses operative components of the hearing aid. The housing includes an aperture therethrough, at a boundary between the housing interior and exterior. The aperture is in communication with the housing interior and exterior. A switch is associated with one or more of the operative components of the hearing aid. A switch actuator is mounted on the housing, at or in the said aperture, which actuator is operable by a user externally of the housing.

The housing may further comprise a barrier which extends across the aperture. The barrier may extend between the housing interior and the housing exterior, the barrier being preferably secured within the housing. For example, the barrier may be integral with the housing, in particular it may be integral with an internal surface of the housing. The barrier may be a barrier against the passage of contaminants between the exterior and interior of the housing. In this way, the barrier can provide effective protection for the internal components of the hearing aid. The barrier preferably prevents the passage of contaminants, between the exterior and interior of the housing, in particular by stopping ingress of contaminants such as moisture or sweat or dust or microbes or such like. In particular, the barrier may be a continuous barrier. The barrier may extend fully across the housing aperture, for example, closing off any possibility of ingress of contaminants into the housing, which may otherwise tend to pass between the actuator and the perimeter of the aperture in the housing. The barrier material is preferably flexible. The barrier is thereby preferably a flexible barrier. It allows mechanical operation of the actuator e.g. by manipulation by a user, to effect actuation, i.e. a switching action, of the associated switch.

In aspects, this disclosure relates to a hearing aid housing supporting an externally operable switch actuator, and having a barrier separating the actuator from an associated internal switch inside the hearing aid housing. In an aspect of the present disclosure, there is provided a hearing aid as defined in appended claim 1. Further preferred features thereof are defined in subclaims 2-14. A method of manufacturing a housing for such a hearing aid is defined in appended claim 15. Further details, features and advantages are discussed in the specification, also with reference to appended drawings.

This aspect and various further aspects of this disclosure may be best understood from the following detailed description taken in conjunction with the accompanying figures. The figures are schematic and simplified for clarity, and they just show details to improve understanding of the present subject-matter, while other details are left out. Individual features of each aspect may be combined with any or all features of other aspects unless prevented by the laws of physics or unless manifestly excluded for another reason. These and other aspects, features and/or technical effect will be apparent from and elucidated with reference to the illustrations described hereinafter in which:

### BRIEF DESCRIPTION OF DRAWINGS

FIG. 1a schematically shows an external side view of a background example of a so-called BTE type hearing aid with a sound tube; and

FIG. 1b schematically shows an external side view of a background example of a so-called BTE type hearing aid with a sound tube and a sound conduit with an earpiece; and

FIG. 1c schematically shows an external perspective view of a background example of a so-called RITE or RITC type BTE hearing aid with a remote loudspeaker; and

FIG. 1d schematically shows an external side view of housing segments of a background BTE type hearing aid; and

FIG. 1e schematically indicates a perspective view of a chassis supporting some operative internal components or circuitry of a hearing aid;

FIG. 2 schematically shows a cross-section perspective view illustrating a background hearing aid actuator with associated switches, in the form of a rocker at a housing; and

FIG. 3 illustrates a cross-section view illustrating a pusher type actuator at a hearing aid housing and including a barrier, in an advantageous arrangement according to aspects of the present disclosure; and

FIG. 4 illustrates a cross-section view illustrating a pusher type actuator in an advantageous arrangement according to further aspects of the present disclosure; and

FIG. 5 illustrates a cross-section view illustrating a pusher type actuator in an advantageous arrangement according to still further aspects of the present disclosure; and

FIG. 6 illustrates a cross-section view illustrating a pusher type actuator in an alternative advantageous arrangement according to further aspects of the present disclosure; and

FIG. 7 illustrates a cross-section view illustrating a rocker type actuator in an advantageous arrangement according to aspects of the present disclosure; and

FIG. 8 illustrates a cross-section view illustrating a rocker type actuator in an advantageous arrangement according to additional aspects of the present disclosure; and

FIG. 9 illustrates a cross-section view illustrating a rocker type actuator in an advantageous arrangement according to additional aspects of the present disclosure; and

FIG. 10a shows an external perspective view of a hearing aid housing segment illustrating aspects of the present disclosure; and

FIG. 10b shows an internal perspective view of a hearing aid housing segment shown in FIG. 10a, illustrating aspects of the present disclosure; and

FIG. 10c shows a cross-section view of a housing segment as shown in FIGS. 10a-b, revealing additional features; and

FIG. 11a shows an external side view of a hearing aid housing showing aspects of the present disclosure including exemplary actuator mounting details; and

FIG. 11b shows a cross-section view of a housing segment as shown in FIG. 11a, revealing additional features.

FIGS. 12a-d show a cross-sectional, partial views illustrating parts of a co-moulding operation.

FIGS. 13a-d show a cross-sectional, partial views illustrating parts of a variant of a co-moulding operation.

The figures are schematic and simplified for clarity. These indicate details for better the understanding of the disclosure, while other details are left out. Throughout, the same reference signs are used for identical or corresponding parts.

Further scope of applicability of the present disclosure will become apparent from the detailed description given hereinafter. However, the detailed description and specific examples, while indicating preferred embodiments of the disclosure, are given by way of illustration only. Other embodiments may become apparent to those skilled in the art from the following detailed description.

### DETAILED DESCRIPTION

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details.

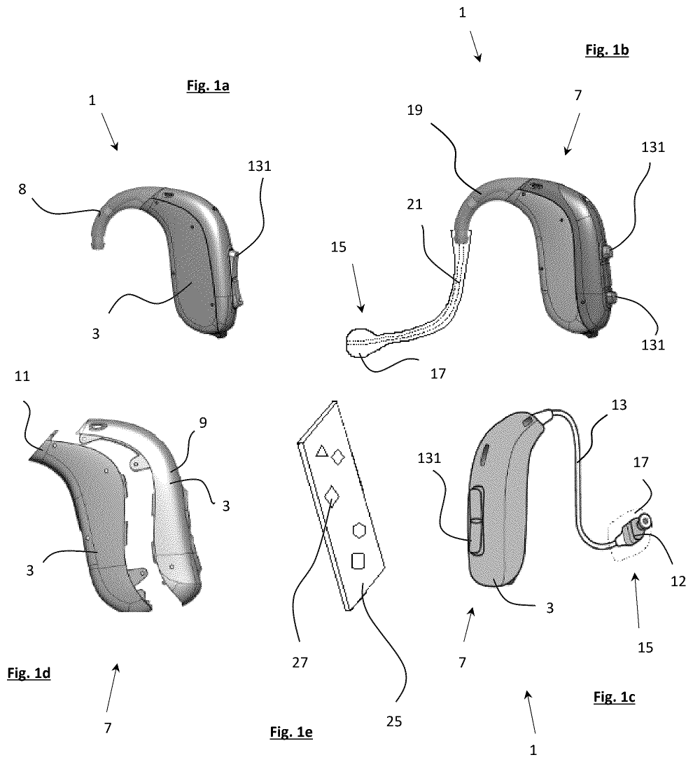

A hearing aid 1, as illustrated in FIGS. 1a-c may form part of a hearing system. For example, a hearing system may comprise a portable hearing aid 1 to be worn by a user on, in, at or close to the ear, which hearing aid 1 may additionally be associated with one or more auxiliary devices (not shown) such as a dedicated remote control or a correspondingly adapted device such as a smartphone, or other portable or wearable electronic device e.g. a smartwatch or the like. The hearing system may be adapted to establish a communication link between the hearing aid 1 and the auxiliary device to allow data or information exchange between them (e.g. control and status signals, possibly audio signals). The auxiliary device may thereby provide ordinary or enhanced operational control of the hearing aid 1. In some cases, an auxiliary device may enhance hearing aid functionality. For example, function of a remote control may be implemented in a smartphone, the smartphone possibly running a so-called ‘app’, allowing to control the functionality of the audio processing device via the smartphone—the hearing aid(s) comprising an appropriate wireless interface to the smartphone, e.g. based on Bluetooth® or another standardized or proprietary scheme. The auxiliary device may be, or may function as, an audio gateway device adapted for receiving a multitude of audio signals from extrinsic devices (not shown). Such extrinsic devices may typically include entertainment or information devices such as a TV set, in-car entertainment or information equipment, a music player, a telephone apparatus, e.g. a mobile telephone or a computer, a PC, a wireless microphone, etc., The auxiliary device may be adapted for selecting and/or combining an appropriate one of the received audio signals, or a combination thereof, for transmission to the hearing aid 1. In some cases, two hearing aids 1 may be adapted to communicate together, thereby constituting a so-called binaural hearing system. A binaural hearing aid system may thereby also be understood as a hearing aid system.

The hearing aid 1 may be configured to be worn in a variety of ways. Currently, hearing aids can be configured in various types, chiefly including behind-the-ear (BTE) types—as illustrated in FIGS. 1a-c—or various configurations worn in the ear. BTE types are generally configured as a primary unit arranged behind the ear, which unit houses most of the hearing aid components. BTE types generally comprise an associated earpiece 15 positionable in the user's ear canal and from which output sound to the user's ear is emitted. BTE type hearing aid devices 1 may include a receiver within the primary housing 7 or a receiver may be comprised in an associated earpiece 15. When the output sound receiver (a.k.a. loudspeaker) is comprised in the primary housing 7, then the BTE device generally also includes an output sound tube 19. This sound tube 19 may be incorporated in a in a so-called hook 8 (see FIGS. 1a-b) also known as a sound hook. The sound tube 19 leads radiated acoustic signals into the ear canal, possibly via a sound conduit 21 to an earpiece 15, as shown in FIG. 1b. Sound may emerge from an aperture of the sound conduit 21 at the earpiece 15, which earpiece 15 is positionable in the ear canal of a user. When associated with a sound tube 19 and/or sound conduit 21, as per the hearing aid types shown in FIGS. 1a-b, an earpiece 15 may comprise a sound outlet aperture. A BTE type hearing aid may alternatively be configured with an output transducer to be placed in the ear canal (see e.g. FIG. 1c). The output transducer, e.g. a receiver 12, may be arranged externally of a hearing aid primary housing 7. It may be functionally associated with the housing 3 of the hearing aid 1. In particular, it will be configured to receive an output signal from the hearing aid circuitry e.g. via a receiver connector 13 such as a connector wire. Such a BTE device may be referred to as a receiver-in-the-canal or receiver-in-the-ear (RITE) type BTE device, an example of which is illustrated in FIG. 1c. Additionally, an ear grip (not shown) may be provided to stabilise the earpiece 15 in the user's ear. An ear grip may typically be associated with a sound tube 21 or with an earpiece connector 13. The ear grip may retain, locate or stabilise the earpiece 15 and/or sound tube 21 and/or earpiece connector 13 in the outer ear entrance to the ear canal. An ear grip may for example be in the form of a moulding and/or a flexible wand. The earpiece 15 may have a sound outlet aperture in acoustic communication with the hearing aid sound output transducer receiver, whether it is in the housing 3, such as inside a primary housing 7, or within the earpiece 15 itself. An earpiece 15 may be provided in association with an earpiece moulding 17, the purpose of which is to securely seat the earpiece 15 in the ear canal of a user. An earpiece moulding 17 may have an additional function of sealing the inner ear from outside sound. An earpiece moulding 17 may be joined to a sound conduit 21 or it may be attached to an in-the-ear receiver unit 12, e.g. associated with a connector 13. An earpiece moulding 17 may comprise a standard fitting element, possibly available in a range of sizes. For example, an earpiece moulding 17 may have a standard shape, sometimes referred to as a dome or tip or earbud. As mentioned, an earpiece 15 for a receiver 12 may optionally be a fitted, moulded earpiece 15; it may be individually shaped to the inner ear canal of a user.

In addition to so-called BTE types, whether with sound conduit 21 or with a remote receiver 12, various configurations of hearing aid 1 may be worn in the ear, which is to say that the hearing aid 1, including its main housing 3, is configured to be positioned entirely or partly in the pinna and/or in the ear canal. In-the-ear devices (not shown) are usually housed in a housing which is shaped or individually moulded to correspond to the particular shape of the ear or ear canal of the intended user. These devices may include substantially all hearing aid components housed in a single unit. The unit to be placed in the ear may comprise a housing 3 or a combination of a housing 3 with an earpiece 15. Depending on size and/or functionality, these units may be configured in various ways, examples of which include: ITE (in the ear), ITC (in the canal) CIC (completely in the canal) or IIC (invisible in the canal) or others.

A housing 3 of a hearing aid 1 may in particular internally encompass operative components 27 of the hearing aid 1. The housing 3 may be comprised of more than one part or segment. In other words, the housing 3 may be assembled into a hearing aid housing 3 from multiple housing segments such as a first housing segment 9, and a second housing segment 11. For example, and as can be seen in FIG. 1d, a hearing aid housing 3 may be comprised of a first housing segment 9 and a second housing segment 11. In the example shown, the first housing segment 9 may be a dorsal housing segment of a BTE type hearing aid 1. In the example shown, the second housing segment 11 may be a ventral segment of a BTE type hearing aid 1. It is not excluded that a housing 3 may comprise a third or still additional housing segments although this is not shown in FIG. 1d. For example, a third housing segment may be configured as an access segment. An access segment may be provided in connection with a first and a second housing segment 9, 11. For example an access segment may be openable and closable; it may allow insertion or retrieval of an internal component such as a battery or such as other operative components 27 or such as a chassis 25. Alternatively, a hearing aid 1 with a first and second housing segment 9, 11, may be separable to give access internally of the housing 3, e.g. to allow insertion or retrieval of internal parts such as a battery of other internal operative components 27 or such as a chassis 25. The housing 3 defines an internal region, within the housing 3, i.e. inside the hearing aid housing 3, and an external region, outside the hearing aid housing 3 and thereby outside the hearing aid 1. FIGS. 1a-c show external views of a hearing aid 1, whereas FIG. 1d shows a side view in which first and second housing segments 9, 11 of a hearing aid are separated—or in an opened configuration-thereby revealing both an internal region and an external region in relation to the hearing aid housing 3.

Operative components 27 may include, without limitation, for example one or more input devices such as microphones; band filters; signal processing components; amplification components; one or more switches 29; and/or related circuitry. Such internal operative components 27 which form the main workings of a hearing aid 1, which enable the hearing aid 1 to perform its functions, may be generally known and are discussed in other parts of this disclosure. One or more operative components 27, which are referred to in parts of this disclosure, may conveniently be mounted on a chassis 25, as illustrated schematically at FIG. 1e. A chassis 25 may be fixedly arranged in the hearing aid housing 3. A housing 3 as illustrated may form the main housing of a hearing aid 1. The chassis 25 with operative components 27 mounted thereon is intended to be internally mountable within the housing 3. To this end, a chassis 25 may be secured in either segment 9, 11 of the housing 3, e.g. secured to a first housing segment 9 or a second housing segment 11.

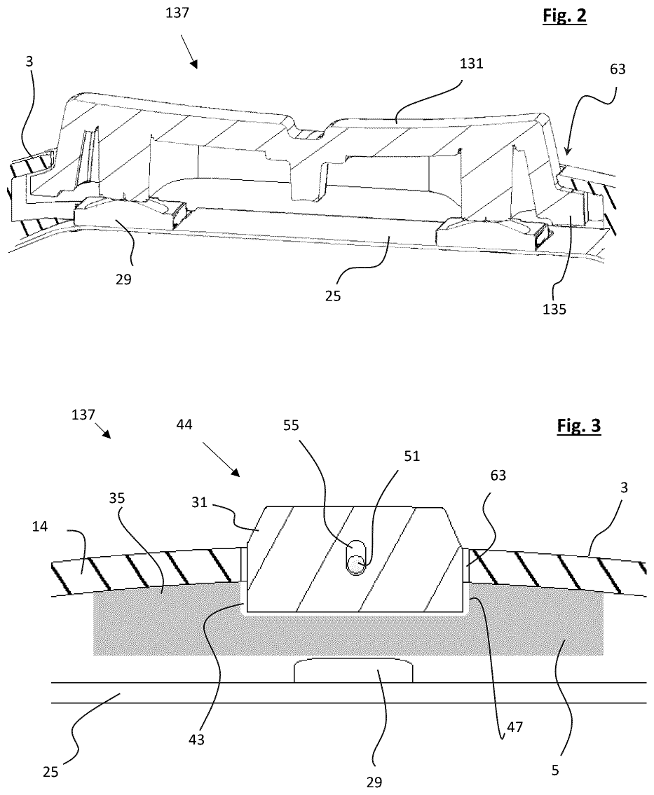

In many respects, a hearing aid 1 is configured to operate automatically. Nevertheless, for certain modes of operation, various selections or adjustments may be input by a user. This may in some cases be achieved remotely, e.g. using an auxiliary device such as a smartphone or remote control associated with the hearing aid 1, such as in a hearing aid device system. It may nevertheless be advantageous to allow the possibility for a user to make adjustments by means of controls, in particular switches 29, provided in the hearing aid 1. To this end, a hearing aid 1 may be provided with one or more actuators 131 or buttons, associated with one or more respective switches 29 within the hearing aid housing 3. Examples of actuators 131 in the form of buttons such as push-buttons or rockers are shown on the hearing aid housings 3 illustrated in FIGS. 1a-c or FIG. 2. A more detailed, cross section, view of switch assembly 137 including an actuator 131 at a hearing aid housing 3 is illustrated in FIG. 2. In particular, a housing 3, or a segment 9, 11 thereof, comprises an aperture 63 in, or at, which an actuator 131 may be accommodated or received. The actuator 131 is mounted in such a way as to allow actuation of one or more associated switches 29 inside the housing 3. Thus, an actuator 131 is mounted at an aperture 63 to allow actuation of one or more internal switches 29 by a user operating the actuator 131. In the background art example illustrated in FIG. 2, contaminants—e.g. of the type likely to be encountered during use of a hearing aid—may not be prevented from passing from an exterior region of the housing 3 to an internal region of the hearing aid. In particular, there is shown no barrier against ingress of contaminants through an aperture 63 in the housing 3 in which the actuator 131 is positioned. In this regard, in the illustrated example in FIG. 2, the primary function of the chassis 25 would be to support internal components of the hearing aid, such as e.g. switches 29.

With reference to FIGS. 3-11, in one aspect of this disclosure, there is provided a hearing aid 1 comprising a housing 3 defining an interior and an exterior in relation to the hearing aid housing 3. The housing 3 encloses at least one internal switch 29, associated with one or more operative components 27 of the hearing aid 1. The housing 3 includes an aperture 63 therethrough at a boundary between the interior and the exterior of the hearing aid housing 3. The aperture 63 is thereby in communication with, the interior and the exterior of the hearing aid housing 3. A switch actuator 31 is mounted on or in or at the housing 3 such that it is operable by a user externally of said housing 3. i.e. the switch actuator 31 may be accessed and operated by a user acting externally of the housing 3. A switch actuator 31 may be of any suitable type and may in particular be known as a button. Types of actuators 31 which may include a rocker 37 or pusher 44. As can be seen in FIGS. 3-11, a hearing aid 1 comprises a housing 3. The housing 3 encloses one or more operative components 27 of the hearing aid 1. A switch 29, and/or one or more additional switch 29, may be one such an operative component 27. The housing 3, in particular, a first segment 9 thereof, includes an aperture 63 therethrough, which defines a boundary between, and is in communication with, both interior and exterior regions of the housing 3. A switch 29 is associated with one or more operative components 27 of the hearing aid 1. A switch actuator 31, operatively associated with a switch 29, is mounted on the housing 3, at or in the aperture 63. The actuator 31 is operable by a user externally of the housing 3.

An actuator 31 such as a pusher 44 or rocker 37 may be externally mountable on or removable from the housing 3. In particular, the actuator 31 may be insertable into the housing aperture 63 from a direction and/or from a side which is external of the housing 3. The housing 3 may further comprise a barrier 5 which extends across the aperture 63. The barrier 5 may extend continuously between the housing interior and the housing exterior, the barrier 5 being preferably secured within the housing 3. The barrier 5 may be a barrier against the passage of contaminants between the exterior and interior of the housing 5. The primary function of the barrier 5 may be the prevention of the passage of contaminants between the exterior and interior of the housing 5. An interior and an exterior of the housing 3 may correspond to an interior and an exterior region respectively. Thus, when assembled into a hearing aid 1, an interior and an exterior of the housing 3 may correspond respectively to an interior and an exterior of the hearing aid 1. A said barrier 5 is preferably interposed between an actuator 31 and the housing interior. A said barrier 5 is preferably interposed between an actuator 31 and a switch 29 at the housing interior. A barrier 5 preferably extends between a said actuator 31 and the housing interior. A said barrier 5 preferably extends between an actuator 31 and a switch 29 at the housing interior. As illustrated, an actuator 31 may preferably be arranged externally of a barrier 5. In other words, an actuator 31 and a switch 29 may each be respectively arranged near opposite faces of a barrier 5. Said barrier 5 may preferably extend between an actuator 31 and a switch 29

A housing 3 or a housing segment 9, 11 may comprise a shell 14. A shell 14 may comprise a respective internal and external major surface. A shell 14 of a housing 3 may provide structure and/or rigidity to a housing 3. A shell 14 may be provided in the form of a shell layer of a housing 3. A housing 3 may in particular exhibit an external surface of a hearing aid 1, which external surface may be an external surface of a shell layer 14 of said housing 3. For example, a hearing aid housing 3 may exhibit a painted external surface, which painted surface may be a shell layer 14 surface.

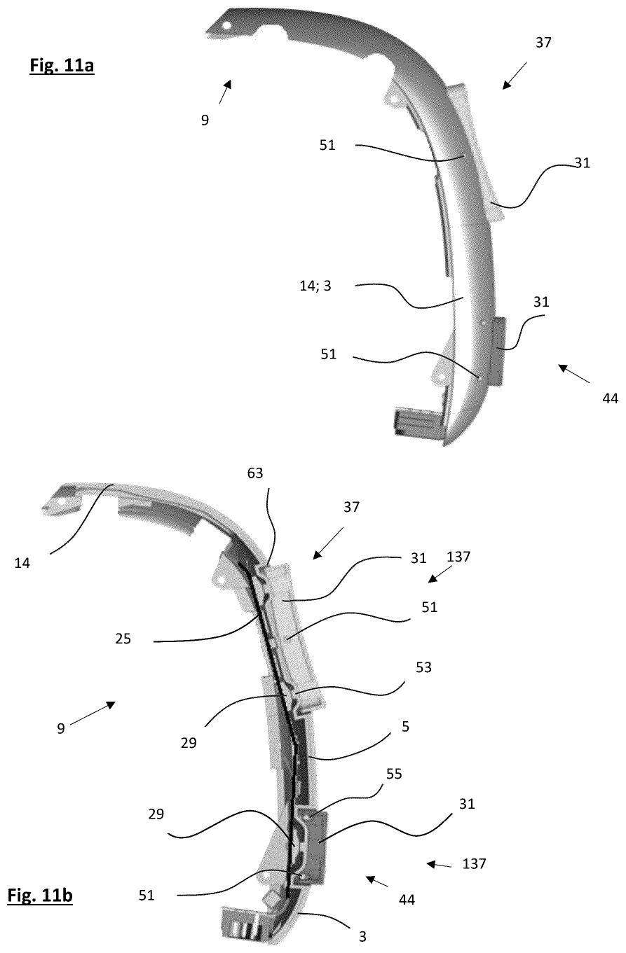

Operative components 27 of the hearing aid 1 may in particular be internal operative components 27 thereof. One or more said operative components 27 may be mounted internally of the housing 3, for example on a chassis 25. As illustrated in FIGS. 3-11, a chassis 25 may be fixedly secured inside the housing 3. As can be seen in more detail in FIG. 11b, a chassis 25 may, for example be fixedly secured inside the housing 3 by attachment to a chassis support surface in the housing, for example, in a first or second segment 9, 11 thereof. As can be seen for example in FIG. 11b, a housing 3 may enclose more than one such chassis 25. Any or all embodiments may include one or more than one chassis 25. In particular, a chassis 25, including operative components 27 thereon, may be fixed in a first or second segment 9, 11 of the housing 3. In embodiments, a switch 29, associated with one or more operative components 27, may be mounted fixedly on the chassis 25. Optionally, two or more switches 29 may be mounted on a chassis 25. A switch 29 may be a microswitch. One or more switches 29 may be mounted on one or more chassis 25, each chassis 25 being fixed at a support surface in a housing 3. In particular, a chassis 25 may be fixed to a rigid shell 14 of a housing 3 or of a housing segment 9, 11. For example, a chassis 25 may be fixed at a support surface of a relevant shell 14. A chassis 25 may be positioned in the housing 3, mounted to a support surface therein, such that a switch 29 on the chassis 25 is located in correspondence with an associated actuator 31 such that a switching action of the actuator 31 by user will operate the switch 29 or those switches 29 with which the actuator 31 is operatively associated. Also to this end, an actuator 31 is mounted at the housing 3, e.g. at a shell 14 thereof, located in correspondence with an associated switch 29 inside the housing 3. FIGS. 3-9 show details of switch 29 and actuator 31 arrangements at an aperture 63 of a hearing aid housing 3 or at a shell 14 thereof. FIGS. 10a-c and 11a-b show various views of a hearing aid housing 3 including a range of examples of aforementioned features.

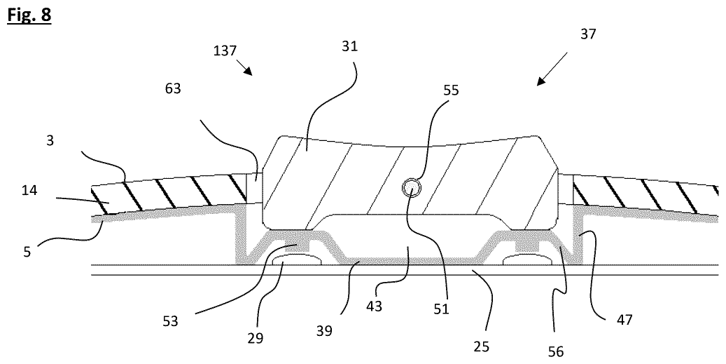

An actuator 31, may be of any type, such as for example a rocker 37, an example of which is shown in FIGS. 8-11 or in FIGS. 1a and 1c; or such as a pusher 44, as shown in FIG. 1b or FIGS. 3-7 and others or a hinge type actuator. A rocker 37 may often, though not exclusively, be associated with a sound intensity adjustment function (e.g. volume up or down adjustment, possibly also a mute setting), whereas a pusher 44 may often, though not exclusively, be associated with selection of, or toggling between, hearing aid pre-programmed or programmable modes of operation, possibly including on-off switching.

In order to allow for the required functional movement of an actuator 31, mounted at an aperture 63, there may be at least some space between the two, in the form of a gap between an outer periphery of the actuator 31 and a perimeter edge of the aperture 63, in particular, the innermost perimeter of the aperture 63. The mounting arrangements for an actuator 31 may, depending on the particular design, allow for easy operability and possibly also easy assembly and fit. For these and/or other reasons, an actuator 31 may be more or less loosely positioned within an aperture 63. With reference to FIG. 2, showing an exemplary background information type actuator 131 and switch arrangement at a housing 3, an actuator 131 may be provided with an outermost peripheral flange 135 as part of the mounting arrangements, for ensuring its physical retention at its mounting in the housing aperture 63. In particular, the peripheral flange 135 describes a bigger lateral or radial footprint than the lateral or radial extent of the aperture 63. Thus, a further benefit of such a flange 135 on the actuator 131 in the aperture 63 may reside in that the flange 135 may to some degree inhibit ingress of particles into the housing 3. These particles or other contaminants such as sweat or fluids, during use of the hearing aid 1, may have a tendency over time to pass from outside the housing 3, through a gap in the aperture 63, to the inside of the housing 3. The term contaminants is here used to denote those contaminants or contaminating substances which are likely to be encountered during the useful life of a hearing aid. Contaminants may in particular be airborne or on the skin or may for example find their way onto clothing or in hair of a user. Contaminants may be in solid or liquid or gaseous form; e.g. they may be particulate or in the form of vapour or droplets. Contaminant may include any substance or form of a substance not intended to be provided inside a hearing aid, or not intended to be loose or mobile inside a hearing aid. A barrier 5 may be capable of preventing ingress of such contaminants. A barrier 5 may be capable of preventing ingress of such contaminants, e.g. in the same way as the housing or shell thereof also protects internal components from such contaminants. In other words, the barrier 5 may be seen as a continuation of the housing at least in as much as they both prevent the ingress of contaminants. A primary function of a housing may be seen as the containment of internal components. Another primary function of a housing may be seen as the protection of internal components. Another primary function of a housing may be seen as enclosing or supporting an arrangement of internal components. A secondary function of a housing may be seen as protecting internal components against external contaminants. A primary function of a barrier may be seen as protecting internal components against external contaminants. In addition to this, a secondary function of a membrane type barrier may be seen as permitting the transmission of a switching action from an externally arranged actuator to an internally arranged switch. Particles or fluids may contaminate and can cause damage to the sophisticated, delicate hearing aid components 27. In some cases, it has been suggested or known to treat hearing aid parts and/or internal components 27 with hydrophobic coatings. These coatings are used to protect the hearing aid 1, especially its internal electronics, against contaminants such as or including of sweat and corrosion, which may have entered the housing 3. In some instances, hydrophobic coatings may be based upon or include agents from a family of chemicals sometimes known as PFAS. These compounds have long-term stability properties which, though useful, may at the same time exceed the functional requirements for which they are intended or may exceed the intended life of the products with which they are used. Alternative hydrophobic or protective or corrosion-resistant coating compounds are available although many of these have a level of effectiveness which is insufficient to provide the protection required for electronic components in a hearing aid 1. Improved protection of hearing aid internal components resulting from implementation of one or more aspects according to the present disclosure may preferably reduce or remove a need for water-repellent coatings on components, and/or it may enable the use of alternative coating materials. For example, the invention may enable hearing aids to be provided without the use of so-called PFAS coating materials.

In aspects of the present disclosure, a barrier 5 against the passage of contaminants may correspond to water resistance. In aspects of the present disclosure, a barrier 5 against the passage of contaminants may correspond to protection against ingress of contaminants corresponding to IP54 or above. In aspects of the present disclosure, a barrier 5 against the passage of contaminants may correspond to a protection against ingress of contaminants corresponding to IP55 or above. In aspects of the present disclosure, a barrier 5 against the passage of contaminants may correspond to a protection against ingress of contaminants corresponding to IP65 or above. In aspects of the present disclosure, a barrier 5 against the passage of contaminants may correspond to a protection against ingress of contaminants corresponding to IP56 or above. In aspects of the present disclosure, a barrier 5 against the passage of contaminants may correspond to a protection against ingress of contaminants corresponding to IP66 or above. In aspects of the present disclosure, a barrier 5 against the passage of contaminants may correspond to a protection against ingress of contaminants corresponding to IP67 or above.

Therefore, in aspects of the present disclosure a barrier 5 may be advantageously secured in the housing 3 at an aperture 63 thereof. The barrier 5 may thereby in particular extend between the housing interior and the housing exterior. The barrier 5 may in particular be a barrier against the passage of contaminants between the exterior and interior of said housing 3, in particular through an aperture in said housing 63. In places where there is no aperture, 63, the housing itself will prevent entry of contaminants such as dust, dirt, moisture etc., because these cannot penetrate through the material of the housing itself. The barrier 5 may in particular be a barrier against the ingress of contaminants between the exterior and interior of said housing 3. The barrier 5 may be integral with said housing 3. In particular, the barrier 5 may be integral with a shell 14 of the housing 3. The barrier 5 may preferably be provided on an internal face of the housing 3 such as for example on an internal face of a shell 14 of said housing 3 or segment thereof. The barrier 5 preferably extends over a sufficient portion of an internal face of a housing 3 and across an aperture 63 in the housing 3 to thereby close the aperture 63 across which it extends. The barrier 5 is preferably continuous and defines a boundary between the housing interior and the housing exterior, notably at the aperture 63 across which the barrier extends. Herein, the term ‘continuous’ may be understood to designate a particle—and/or liquid-impermeable boundary property of the barrier 5. The barrier 5 thereby preferably physically isolates internal components 27 of the hearing aid 1 from the external environment. Preferably, the barrier 5 is integral with the housing 3, notably with an internal face thereof. Preferably, the barrier 5 is co-moulded with the housing 3, e.g. with a shell layer 14 thereof. Preferably, the barrier 5, in particular a layer thereof, may be fused with an internal face of the housing 3. Preferably, the barrier 5, in particular an interface layer 123 thereof, is fused with the material of the internal face of the housing 3. The barrier 5 is preferably configured to prevent ingress of contaminants such as humidity, moisture, liquids or dirt into the hearing aid 1. Examples and configurations of a barrier 5 at a hearing aid housing 3 may be seen in FIGS. 3-13.

In this way, the barrier 5 provides effective protection for the internal components 27 of the hearing aid 1. The barrier 5 preferably prevents the passage of contaminants, between the exterior and interior of the housing, in particular by stopping ingress of contaminants such as moisture or sweat or dust or microbes or such like. In particular, the barrier 5 may be a continuous barrier. The barrier 5 may extend fully across the housing aperture 63, for example, closing off any possibility of ingress of contaminants into the housing 3, which may otherwise tend to pass between the actuator and the perimeter of the aperture 63 in the housing 3. The barrier 5 material is preferably flexible. The barrier 5 is thereby preferably a flexible barrier. It allows mechanical action of the actuator 31 e.g. by a user to effect actuation, i.e. a switching action, of an associated switch 29. The barrier 5 may comprise a single material layer, or it may be comprised of two or more material layers. The respective material layers may be integral in a single barrier layer or they may be additive, such as in a laminar multilayer arrangement.

As can be seen in FIGS. 3-13, preferably, the barrier 5 extends in a layer within the housing 3. Preferably, the barrier 3 and the portion of the housing 3 with which it is integral form a dual-layered structure. Preferably, the barrier 5 extends radially beyond the said aperture 63. Preferably, the barrier 5 and housing 3 form an integral dual-layered structure in regions which extend radially beyond one or more housing aperture 63. Still preferably therefore, the housing 3 may comprise more than one aperture 63. The barrier 5 may be formed as a single layer extending within and about an interior surface of a shell 14 of the housing 3. The barrier 5 may thereby extend across said more than one said aperture 63. E.g. the housing 3 may comprise two or more apertures 63 therethrough, each aperture 63 being in connection with an interior and an exterior of said housing 3. The barrier 5 may extend in a single layer within the housing 3, e.g. within a shell layer 14 thereof, thereby extending across two said apertures 63 or three said apertures 63 or more etc. Alternatively, a respective barrier 5 may be provided at each one of several apertures 63. Each or any aperture 63 may be an actuator aperture. Each aperture 63 may correspond with an associated switch 29 inside the housing. Preferably, the aforementioned dual-layered structure of the housing 3 and barrier 5 may extend over a region of the housing 3 comprising one aperture 63 or more than one aperture 63 e.g. two or three or four such apertures 63. A housing 3 may comprise a barrier layer 5 and a shell layer 14.

A barrier 5 may comprise or may predominantly comprise or may be comprised of a membrane 35. The barrier 5 may be provided in the form of a membrane 35. Therefore, in a further aspect, the barrier 5 may comprise a membrane 35, which membrane 35 may be a membrane layer. In particular, the membrane 35 may be a flexible membrane. The barrier 5 may be wholly, or partially comprised of a said membrane 35. A barrier 5 according to any aspects of this disclosure may be wholly or primarily comprised of said membrane 35. A barrier 5 may comprise a membrane 35 and one or more additional layers or coatings. A membrane 35 is indicated in many illustrated embodiments herein. It may optionally be included in connection with all illustrated embodiments or all embodiments. In particular, a membrane layer 35 of said barrier 5 may be integral with a shell 14 of said housing 3. A membrane layer 35 of said barrier 5 may be bonded with a shell 14 of said housing 3. A membrane layer 35 of said barrier 5 may preferably be co-moulded with a shell 14 of said housing 3. The membrane 35 may in particular be fused together with an internal surface of said shell 14 of said housing 3. The membrane 35 may be bonded together with an internal surface of said shell 14 resulting from a fusion, such as a melt bond or other molecular entanglement, at an interface 123 between the membrane 35 and the shell surface. More particularly, the membrane 35 may be integral with and coextensive with a region of the shell 14 of the housing 3. More particularly, the membrane 35 may be is integral with and coextensive with a region of an internal surface of the shell 14, or shell layer, of the housing 3. The membrane 35 is preferably integral with and coextensive with a region of the shell 14 of the housing 3, which region preferably encompasses an area less than the entire internal surface area of the shell 14. Therefore, in a hearing aid 1 according to this disclosure, a barrier 5 may comprise a flexible material, more flexible than the material of the housing 3, in particular, more flexible than a material of a shell 14 of said housing 3, wherein the barrier 5 may thereby allow an operation action of an actuator 31 to effect actuation of an associated switch 29. In particular a membrane 35, or membrane layer, of said barrier 5, may comprise a flexible material, more flexible than the material of said housing 3, wherein said membrane 35 allows an operation action of the actuator 31 to effect actuation of an associated switch 29. The membrane material may be softer than the material of a shell 14. The membrane material may be more elastic than the material of a shell 14. The housing 3 may comprise a rigid shell 14 integral with a flexible membrane 35. The housing 3 may comprise a resilient, rigid shell 14 integral with a resilient, flexible membrane 35. The housing 3 may comprise a resilient, rigid shell 14 integral with a resilient, soft, flexible membrane 35.

Preferably, the housing 3, in particular a shell 14 thereof, is made from or predominantly made from a first, relatively stiff material. Preferably the barrier 5 or a membrane of said barrier 5, comprises or predominantly comprises or is comprised of a second, relatively soft material, preferably an elastomeric material. For example, the housing material may be relatively stiff with a Young's Modulus above about 800 MPa, preferably above 1000 MPa, still preferably above 1200 MPa. The housing 3 may be made from plastics material such as thermoplastic material. The primary material constituting the barrier 5 e.g. a primary material of a membrane thereof, may be relatively soft, for example having a Young's Modulus below 50 MPa, preferably below 30 MPa, still preferably below about 25 MPa. The barrier may be made from elastomeric material such as a thermoplastic elastomer (TPE) or a thermosetting material such as e.g. liquid silicone rubber (LSR).

In alternative aspects, the barrier 5, in particular a functional membrane 35 thereof, may be co-moulded with the housing 3 e.g. with a shell 14 thereof. The co-moulding material of the barrier 5 may be flexible. E.g. may be softer and/or more elastic than the material of a shell 14 of the housing 3. The co-moulded housing 3, or e.g. a shell 14 thereof, and the barrier 5 may in particular be formed in a two-component moulding process. In any or all of the illustrated examples in FIGS. 3-13, the barrier 5 and/or a membrane thereof may be obtainable in a co-moulding process. The moulding process may be an injection moulding process. This process may include two injection steps of different materials to form a housing 3. These different materials may fuse together at an interface 123 therebetween. The fusion may be achieved by a melting together of one or both said materials at a mutual interface 123 thereof.

In embodiments, a barrier 5 and thereby a membrane 35 thereof, may define a recess 43 at said aperture 63. A recess 43 may be primarily concave, when perceived from an external region of said housing 3. The recess 43 may in particular comprise a side wall 47 and a floor 39, which may be respectively an aperture side wall 47 and an aperture floor 39. The barrier 5, and in particular a recess 43 thereof, may advantageously be contoured to conform to a said actuator 31. Additionally, the barrier 5, and in particular a recess 43 thereof, may advantageously be contoured to conform to a switch 29. Preferably the contours of an aperture floor 39 may define a dome shape having a concavity 56 in an orientation opposite to a primary concavity defined by said recess 43. Preferably, in embodiments, a domed contour of said aperture floor 39 may be positioned in correspondence with a said switch 29.

Advantageously, the barrier 5 may comprise a boss 53 protruding, internally into said housing 3. The boss 53 may preferably be located on an internal face of the barrier 5, with respect to the housing 3. The boss may in particular be located in correspondence with a switch 29. Preferably therefore, the boss 53 may drive a switching action of the switch 29, when said actuator 31 is operated e.g. by a user of said hearing aid 1.

As discussed above, an actuator 31 of said hearing aid 1 can be mounted at a hearing aid housing 3, preferably externally of a barrier layer 5. Still preferably, an actuator 31 may be externally extractable from a said housing aperture 63. In particular a said aperture 63 and a said actuator 31 may each be respectively dimensioned to allow free insertion of a said actuator 31 into said aperture 63. In this way, an actuator 31 may be mounted at an aperture 63 of a housing 3, which aperture 63 is effectively closed, or isolated, from an interior region of said housing 3. Also preferably, a said actuator 63 may be retained in said aperture 63 by one or more externally extractable retaining pins 51 journalled in said housing 3. Preferably, each said retaining pin 51 may be received through a bore 55 in a body of said actuator 31. By these means, an actuator 31 may be secured in a housing 3, in particular in a rigid shell 14 thereof. More particularly, by these means, an actuator 31 may be removably secured in a housing 3, wherein removal of said actuator 63 may be effected without breaching a barrier layer 5 thereat. To this end, one or more retaining pins 51 may be removably journalled in said housing 3, in particular, in a shell 14 thereof.

In aspects, a switching assembly 137 is provided at the hearing aid, in particular at an aperture 63 in a housing 3 thereof. A switching assembly 137 may include at least an actuator 31, and a barrier 5 across said aperture 63. A switching assembly 137 may also comprise one or more retaining pins 51. A switching assembly 137 may be configured to interact with a switch 29 inside said hearing aid housing 3. In the case of a rocker 37 type actuator 31, a bore 55 through the actuator body may be dimensioned to accommodate a retaining pin 51 to thereby allow a rotation action of said rocker 37 about said bore 55. A said rotation motion of a rocker 37 may in particular correspond to a switching action operating a said switch 29. More specifically, a rotation motion of a rocker 37 in a first rotational direction may in particular correspond to a switching action operating a first said switch 29 associated with a said rocker 37, while a rotation motion of the rocker 37 in a second rotational direction, opposite to said first rotational direction, may in particular correspond to a switching action operating a second switch 29 associated with the same rocker 37. In the case of a pusher 44 type actuator 31, a bore 55 through the actuator body may be dimensioned to accommodate a retaining pin 51 to thereby allow a translation action of said pusher 44 about said retaining pin 51. Therefore, in further embodiments, a one or more said bore 55 in said actuator body may provide a loose fit about a said retaining pin 51. In embodiments, therefore, a bore 55 through a pusher 44 may be dimensioned in the shape of a slot. In such an embodiment, the slot shaped bore 55 may have opposing, parallel walls. Opposing walls of a slot-shaped bore may extend in a direction perpendicular to a predominant plane of the aperture 63. For example, the predominant plane of an aperture 63 may correspond to a plane of said housing 3 at a region of said housing 3 in which said aperture 63 is located. Opposing walls of a slot-shaped bore may thereby define the direction of translation of said pusher 44 when actuated by a user to operate an associated switch 29. A bore 55 in a pusher 44 may thereby be relatively dimensioned to allow a translation motion of said actuator 31 about one or more said retaining pin 51, said translation motion corresponding to a switching action operating said switch 29. In examples, such as in e.g. FIG. 5, 6 or 7, a bore 55 in a pusher 44 may be relatively dimensioned to allow a translation motion of said actuator 31 about two said retaining pins 51, said translation motion corresponding to a switching action operating said switch 29. In examples, such as in e.g. FIG. 5 or 7, both bores 55 in a pusher 44 may be relatively dimensioned to allow a translation motion of said actuator 31 about two said retaining pins 51, said translation motion corresponding to a switching action operating said switch 29. In embodiments, the actuator 31 may be a pusher 44 or a rocker 37, retained in said aperture 63 by two externally extractable pins 51 journalled in said housing 3. Optionally, the pusher 44 or a rocker 37 may be retained in said aperture 63 by a single externally extractable pin 51 journalled in said housing 3. External access to and extraction of said retaining pins 51 from a pin hole 58 may allow external servicing of an actuator 31. An actuator 31 may be released from a housing 3 by e.g. extracting one or more retaining pins 51 which form part of an actuator mounting. An actuator 31 may be reattached to a housing 3 by e.g. reinserting the one or more retaining pins 51 which form part of the actuator mounting. This may allow e.g. easy cleaning of said actuator 31 and/or cleaning of a barrier 5 at a recess 43 associated with a housing aperture 63. Removal of an actuator 31 and cleaning of the actuator 31 and/or a recess 43 in a barrier 5 may be effected without exposing the housing interior nor components 27 therein to the exterior around the hearing aid 1, thereby avoiding the risk of contamination during servicing. In embodiments, the hearing aid 1 may comprise more than one actuator 31 mounted at said housing 3 thereof; each said actuator 31 being mounted in corresponding housing aperture 63, and in correspondence with a corresponding switch 29, or with two corresponding switches 29 in said hearing aid 1.

A configuration of said hearing aid 1 with a barrier 5 against ingress of contaminants 14 may protect its internal components 27. Therefore, in embodiments, all said operative components 27 may be free of PFAS coatings and/or free of PFAS. Preferably, said hearing aid 1 including all components 27 may be free of PFAS coatings and/or PFAS-free. The term PFAS refers to compounds which fall in the category understood as per- and polyfluoroalkyl substances. The term PFAS-free may designate the total absence of PFAS compounds. The term PFAS-free may designate the total absence of PFAS compounds at least in a functional sense. Trace amounts may be disregarded, in particular in accordance with regulatory requirements, if applicable. External access to and servicing of actuators may further enhance the protection of the hearing aid 1 and its components 27.

The hearing aid 1 may comprise an actuator 31 in the form of a pusher 44, an example of which is shown in FIG. 3. A pusher 44 may also be known as a floating switch. The pusher 44 may be mounted and thereby retained at an aperture 63 of the housing 3 by means of a pin 51 or to pins 51, journalled in said housing 3, in particular in a shell 14 of said housing 3. To this end, a retaining pin 51 may be received in a respective bore 55 in a body of the actuator 31. The bore 55 may be oversized in relation to a maximum diameter of the retaining pin 51. In particular, the bore 55 may be slot-shaped, e.g. with a minor dimension which may be a transverse dimension as illustrated—i.e. parallel to a plane of said housing 3 at said aperture 63. The minor dimension may be sized to receive said retaining pin 51 or a maximum diameter thereof, in a tolerance fit. The minor dimension of a slot-shaped bore 55 may thereby retain the actuator 31 at its lateral position in said aperture 63. In particular, it may prevent the actuator 31 from butting up against the aperture wall and possibly becoming jammed. In other words, the minor dimension of a slot-type bore 55 may maintain the size of a gap between the actuator 31 and the internal periphery of an aperture 63 in which it is received. The slot type bore 55 may have a normal dimension-perpendicular to a plane of said housing 3 at said aperture 63—which may be a major dimension of the bore 55. The major dimension may be sized to allow a translation movement of the actuator 31 in a direction perpendicular to the plane of said housing 3 at said aperture 63. The extent of the translation movement may be sufficient for the actuator 31 to engage and actuate a switch 29 with which the actuator 31 is associated. In embodiments, the major dimension of an oversized or slot-shaped bore 55 through an actuator body may be of 1.5 or 2 times its minor dimension. In embodiments, the major dimension such of an oversized bore 55 through an actuator body may be greater than 2 or 3 times its minor dimension. A minimum size of a major dimension of an oversized bore 55 may be configured to be great enough to allow for movement of the actuator 31 through a distance sufficient to allow an effective operation of an associated switch 29 by operation of the actuator 31, e.g. by a user operating the pusher 44. A maximum size of a major dimension of an oversized bore 55 may be configured to be less than a dimension which, by actuation of said actuator 31, would lead to a movement of the pusher 44 through a distance greater than required to effect actuation of the switch 29. This maximum may thereby prevent damage of an associated switch 29, e.g. by crushing it if too much force were applied by a user.

Still with reference to FIG. 3, a housing 3 per this disclosure may enclose internal components 27 such as a switch 29, which may be mounted on a chassis 25 also provided internally of the housing 3. The switch 29 is advantageously provided in correspondence with an actuator 31.

The housing 3 may advantageously include a barrier 5 secured at an interior side thereof and extending across the aperture 63. The barrier 5 can prevent ingress of contaminants from a region external of the housing 3 to a region internal of the housing 3. The barrier 5 may be of sufficiently flexible material to allow actuation of the switch 29 when the actuator 31 is pressed e.g. by a user. The barrier 5 may extend as a layer of the housing 3. The barrier 5 may extend as a layer of the housing 3 at a region local to the aperture 63 in which an actuator 31 is received. The housing 3 may also include a shell 14. The shell 14 may also extend as a layer of the housing 3. The shell 14 may be of a rigid material. An external surface of the shell 14 may define an external surface of the housing 3. The barrier 5 may be provided integral with the housing 3. In particular, the barrier 5 may be provided integral with a shell 14 of the housing 3. As shown in FIG. 3, the barrier 5 may be integral with an internal surface of the shell 14. The barrier 5 may include a flexible membrane 35. In embodiments, the membrane 35 may comprise a layer of a barrier 5. In embodiments, the barrier 5 may be comprised of a membrane 35 layer. The barrier 5 may effectively seal the interior of a hearing aid 1 from an exterior of the hearing aid 1, in particular against external contaminants such as moisture, sweat, airborne particles and such like.

As shown in background art FIG. 2, the shape and/or dimensions of the illustrated actuator 131 and aperture 63 necessitate that the actuator 131 would need to be put in place at the aperture 63 from within the housing 3, due i.a. to the presence of a flared portion 135 at the actuator 131. In the FIG. 2 example, the flared portion 135 creates a maximum diameter of the actuator 131 which is greater than a maximum diameter of the aperture 63. In other words, the feature 135 which retains an actuator in place in a housing 3, prevents it from being inserted or removed from without the housing 3. In accordance with the present disclosure, as can be seen for example in FIG. 3, an actuator 31 and an aperture 63 may be mutually dimensioned to allow the actuator 31 to be inserted into the aperture 63 from outside the housing 3. For example, the maximum diameter of the actuator 31 may be smaller than a maximum diameter of the aperture 63. By way of example, and as illustrated in FIG. 3, an actuator 31 may be dimensioned to fit within an aperture 63 to thereby leave a small gap between the actuator 31 and the innermost periphery of the aperture 63. By way of example, and as illustrated in FIG. 3, an actuator 31 may be dimensioned to fit within an aperture 63 to thereby leave a small gap between the actuator 31 and the innermost periphery of the aperture 63. As will be apparent, this allows insertion of the actuator 31 into an aperture 63 with the barrier 5 in place across the aperture 63. The said gap may preferably be present at all points around the actuator 31 when in place in an aperture 63. The gap may preferably be small enough to prevent ingress of excess material into the aperture 63. The gap may be large enough to prevent the housing 3 or a shell layer 14 thereof from interfering with an operation movement of the actuator 31. In embodiments, a side wall 47 of a recess 43 generated by the barrier 5, or a membrane 35 thereof, may define an extension of an internal side wall of the aperture 63. In other words, a side wall 47 of a recess 43 at the aperture 63 may define a continuous surface along with a wall defining an aperture periphery or circumference. For example, the periphery of an aperture 63, facing towards an actuator 31, may be defined by a wall in a shell 14 of a housing 3, which wall extends from an outer surface of the shell 14 to an inner surface of the shell 14 of the housing 3. The extent to which a barrier layer 5 may cover the internal surface of a shell 14 may vary in different embodiments. In some embodiments, a barrier 5 may extend across an area of an internal surface of a shell 14 to extend across an aperture 63 therein and also to extend across a region of the internal surface of the shell 14 which immediately surrounds the aperture 63. In embodiments, an approximate diameter of an area of a barrier layer 5 at an aperture 63 may be of the order of between 2-3 times a maximum diameter of the aperture 63, for example as illustrated in FIG. 3. In alternative embodiments, a barrier layer may extend to cover a greater or much greater proportion of the internal surface of a shell 14 of a housing 3.

A barrier 5 may have a thickness in a direction perpendicular to a shell 14 of a housing 3. A barrier 5 may have an area in a direction parallel to the plane of a shell 14 of a housing 3. A barrier thickness may be substantially constant over the whole area of a barrier 5. In embodiments, a barrier 5 may have a thickness, at a location between an aperture 63 and a switch 29, which corresponds to the distance between the switch 29 and a bottom surface of an actuator 31 when in position, mounted at an aperture 63. In this way, an operation action of the actuator 31, e.g. by a user, will result in operation action of the corresponding switch 29. In embodiments, it may be preferred to ensure that the barrier 5 and/or a membrane 35 thereof, has sufficient elasticity and resilience to maintain an actuator 31 in a start position, i.e. in a retracted position, away from the corresponding switch 29. In other words, when the barrier 5 is at rest, which is to say when it is undeflected by the action of an actuator 31 or by a user operating the actuator 31—e.g. by pushing on it from outside the housing 3—its elastic resilience will maintain the actuator 31 in a start position thereof, which is to say in a retracted position in relation to the corresponding switch 29. In embodiments, the thickness of the barrier 5, in particular across an aperture 63, may be selected to ensure a spring-like shape recovery of the barrier 5 and a displacement of the actuator 31 to a start position thereof, after operation of an associated actuator 31. Additionally or alternatively, the thickness of the barrier 5, in particular across an aperture 63, may be selected to ensure the integrity of the barrier 5 during repeated use, e.g. during or after long term use. Additionally or alternatively, the thickness of the barrier 5, in particular across an aperture 63, may be selected to ensure the impermeability of the barrier 5 against contaminants such as moisture or dirt etc. The barrier thickness may vary locally at different parts of the barrier 5. A barrier 5 may have a greater thickness at a region of the barrier 5 radially outward, surrounding an aperture 63 and a reduced thickness at a region immediately in correspondence with the aperture 63. These contrasting thicknesses may allow for greater barrier flexibility and deformability to allow transmission of the operating action of an actuator to a switch 29. In some cases, it may be preferred to leave a small space between an operative bottom surface of a barrier 5 and a switch 29 with which the operative bottom surface of the barrier 5 interacts. This may allow to prevent unintended triggering of the switch 29 e.g. as a result of accidental contact with an actuator 31. A space between an operative bottom surface of a barrier 5 and a switch 29 may be of the order of half or less than half the thickness of the barrier 5 at that location. A space between an operative bottom surface of a barrier 5 and a switch 29 may be of the order of a quarter or less than a quarter of the thickness of the barrier 5 at that location. A space between an operative bottom surface of a barrier 5 and a switch 29 may be of the order of one sixth or less than one sixth of the thickness of the barrier 5 at that location. A space between an operative bottom surface of a barrier 5 and a switch 29 may be of the order of one tenth or less than one tenth of the thickness of the barrier 5 at that location.

In embodiments, the barrier 5, in particular a membrane 35 thereof, may be moulded together with the housing 3, or more particularly, with a shell 14 of the housing 3. These may in particular be moulded in plastics materials. These may in particular be moulded in polymeric materials. The shell 14 may in particular be moulded in a thermoplastics material, preferably a resilient thermoplastics material. A suitable thermoplastics material may be an amorphous, semi crystalline or crystalline polymeric material. The membrane 35 may in particular be moulded in an elastomeric material. A suitable elastomeric material may be a thermoplastic elastomeric material (TPE). A suitable elastomeric material may be a thermosetting elastomeric material such as a liquid silicone rubber (LSR) material. Preferably, an injection moulding process may be employed for this purpose.

In aspects, there may be provided a method of manufacturing a hearing aid housing 3 configured for a hearing aid 1 of a type set forth herein. The method may include the steps of: providing a mould having a first internal cavity 108 defined by a first internal form; injection moulding a first element in said first internal cavity 108 of said mould 101 by injection of a first plastics material therein; and providing a mould 101 having a second internal cavity 114 defined by a second internal form and which second internal form includes said first element; injection moulding a second element in said second internal cavity 114 by injection of a second plastics material therein. The said first and second elements are thereby co-moulded. Furthermore, either: said first material is a resilient thermoplastics material and said first element forms a shell 14 of said housing 3, and said second material is an elastomeric material and said second element forms a membrane layer 35 of said housing 3; or: said first material is an elastomeric material and said first element forms a membrane layer 35 of said housing 3 and said second material is a thermoplastic material and said second element forms a shell 14 of said housing 3. Wherein, in either case, the shell 14 defines an internal and an external surface thereof and comprises an aperture 63; the said method thereby generating a housing 3 comprising said shell 14 co-moulded together with said membrane 35, said housing 3 thereby comprising a membrane 35 integral with said shell 14. Preferably, the said shell 14 and said membrane 35 are thereby bonded together. Preferably, the said shell 14 and said membrane 35 are thereby bonded along an interface 123 therebetween. The interface 123 may in particular define a boundary between an externally facing surface of said membrane 35 and an internally facing surface of said shell 14. The membrane 35 defines a barrier 5, in particular a continuous barrier 5, across said aperture 63 between the housing interior and the housing exterior. The method further includes assembling an actuator 31 on said housing 3 by inserting said actuator 31 into said aperture 63 from an external region of said housing 3. The method preferably further includes inserting one or more pins through said shell 14 of said housing 3 and through said actuator 31 thereby to mount said actuator 31 on said housing 3 and thereby to retain said actuator 31 in said aperture 63. For improved bonding at an interface 123 the second injection step of the second material may be carried out at a higher injection material temperature than a melting temperature of said first material. This may be especially beneficial in case both the first and the second material are thermoplastics, or where the second material is a thermosetting material.

For example, a shell 14 of a hearing aid housing 3 may be produced by a first injection moulding, of a first material, while a barrier 5, or in particular a membrane 35 thereof, may be produced by a second injection moulding, of a second material. The material of the barrier 5, or membrane 35, may in particular be moulded directly onto the material of the shell 14. Alternatively, a barrier 5, or a membrane 35 thereof, may be produced by a first injection moulding, of a first material, while a shell 14, may be produced by a second injection moulding, of a second material. The material of the shell 14, may be moulded directly onto the material of the barrier 5, or membrane 35 thereof. The second injection moulding step, directly onto the material of the first injection moulding step, may be carried out to ensure that the two materials are integral, in particular such that they are bonded at their interface 123. In this or other aspects, a bond at the interface 123 between the two materials may be achieved by way of fusion together of the two materials. Fusion may result from molecular entanglement of the two materials at their interface 123. This may for example be achieved by ensuring that one, or both, materials is in a flowable state during the second injection step. A flowable state may be a liquid state. In the case of a thermoplastics material, a liquid state may for example be a melted or molten state. In the case of a crystalline thermoplastics material, a flowable state may be achieved by heating the material to a temperature close to, at or above its melting temperature. In the case of an amorphous thermoplastics material, a flowable state may be achieved by heating the material to a temperature close to, at or above its melting temperature range. In the case of a thermoset material, a flowable state may be a pre-cured state of the material, preferably a liquid state thereof. For example, the barrier 5, or a membrane thereof may be co-moulded together with a shell 14 of the housing 3. This may be achieved using a type of co-moulding process sometimes referred to as a “2K moulding” process.

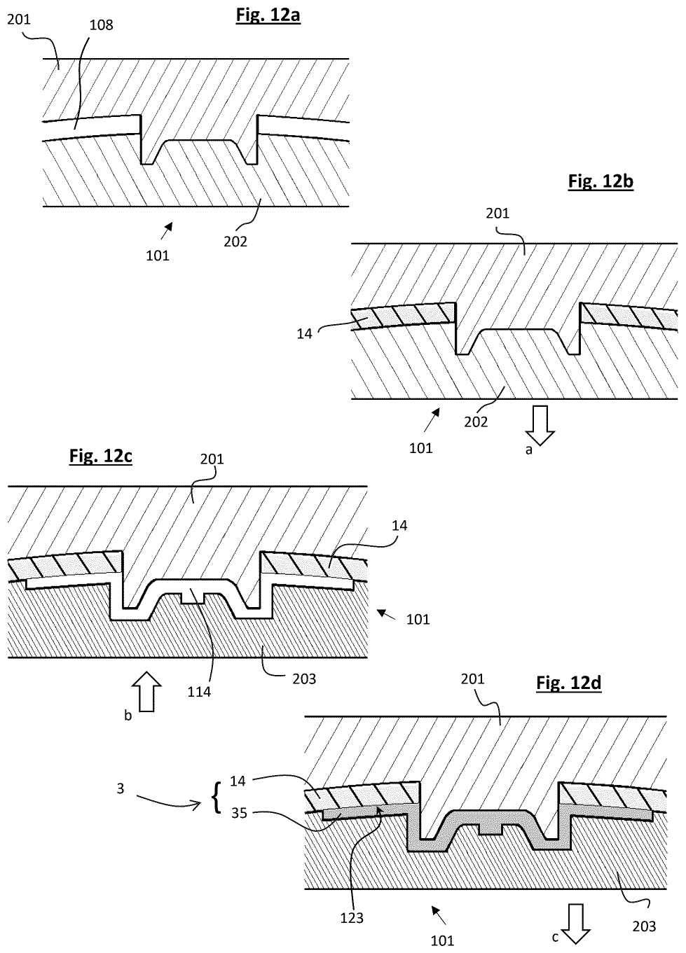

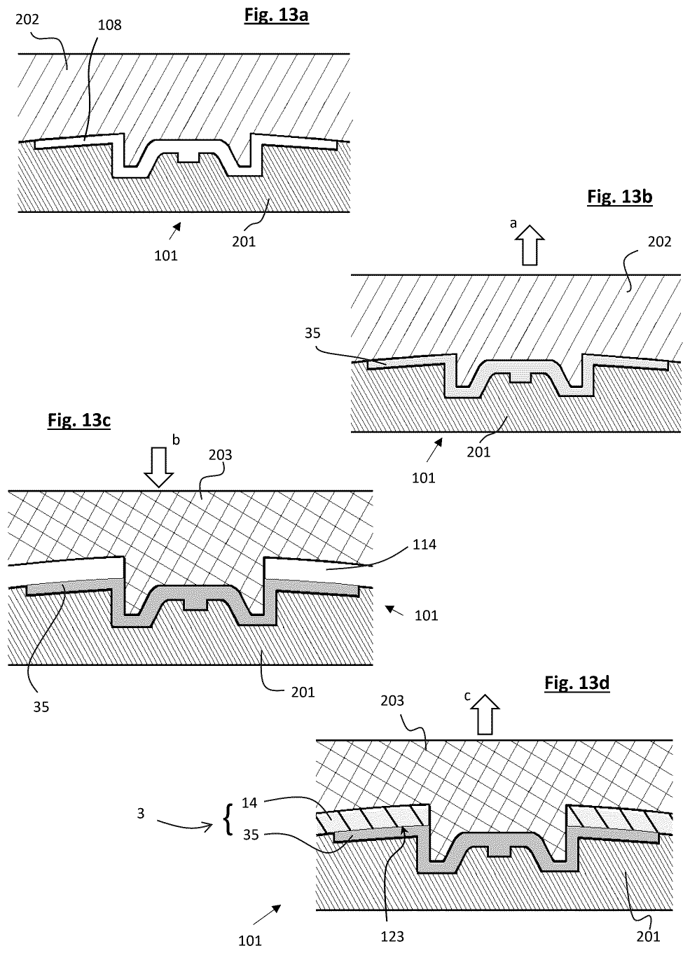

A 2K moulding process may be an overmoulding process. Accordingly, 2K overmoulding may be carried out in a single moulding arrangement, using a single mould with a transferable cavity such that a second material is injected into a second configuration of the mould and is thereby overmoulded on a first material which has been injected into, and moulded in, a first configuration of that mould. In an example of an overmoulding type co-moulding process, the shell 14 resulting from a first injection step in a mould having a first configuration with a first internal form, may remain in the mould while the mould configuration is changed to a second mould configuration having a second internal form, prior to a second moulding step of a second material, i.e. of a membrane 35 in the second internal form of the mould per a second configuration thereof. For example, the barrier 5 may be moulded together with a shell 14 of the housing 3 using a common mould 101, by employing a first injection step of a shell material followed by a second injection step of a barrier material before extracting a co-moulded housing 3. Thus, in embodiments, the barrier 5 may be co-moulded together with the housing 3, or more particularly, with a shell 14 of the housing 3 in an overmoulding process. In embodiments, the barrier 5 may be co-moulded together with the housing 3, or more particularly, with a shell 14 of the housing 3 in a 2K moulding process. By way of example, a shell 14 may be formed in a mould 101 (see FIGS. 12a-d) in a first configuration thereof, having a first internal form with a first internal cavity 108, in a first moulding step. In particular, the shell 14 may be formed by injection moulding of a material of the shell 14 in said first internal cavity 108. The shell 14 may in particular be formed of a resilient plastics material which may be a rigid plastics material. The plastics material of the shell layer 14 of a housing 3 may be a thermoplastic material which, during injection thereof, is in a flowable, possibly molten state. In a cooled state e.g. at room temperature, it may be in a solid, rigid state. A barrier 5 may be formed in a mould 101 in a second configuration thereof, having a second internal form and a second internal cavity 114, in a second moulding step. In particular, the barrier 5, or in particular a membrane 35 thereof, may be formed by injection moulding of a material of the membrane 35 in said second internal cavity 114 of the mould 101. The barrier 5 may in particular be formed of an elastomeric material such as a soft, thermoplastic material or a soft, thermosetting material. The soft plastics material of the barrier membrane 35 may be a soft thermoplastic elastomeric material which, during injection thereof, is in a flowable, possibly molten state. Alternatively, it may be a thermosetting type elastomer such as LSR, injected into the mould in flowable, e.g. liquid, form. The said second internal cavity 114 may partly be defined by an internal surface of said shell 14. A pre-positioning of a shell 14 prior to a second injection step of a second material may result from direct moulding of the shell 14 into a single mould 101 in a first configuration of the mould (see FIGS. 12a and b), then with the shell 14 still in place, transforming the single mould 101 to a second configuration with a second internal form and allowing the first material of the shell 14 to fully or partially solidify (see FIG. 12c). The second internal form may in particular include a second internal cavity 114 for receiving an injection of a second material, namely the material of a membrane 35 (see FIG. 12d). In another example of an overmoulding type co-moulding process, a membrane 35 resulting from a first injection step in a mould 101 having a first configuration and a first internal form with a first cavity 108, may remain in the mould 101 (see FIGS. 13a and b) while the mould configuration is changed to a second configuration with a second internal form and a second internal cavity 114 (see FIG. 13c), prior to a second moulding step of a second material, i.e. of a shell 14 in the second internal cavity 114 (see FIG. 13d).

Still alternatively, a co-moulded housing 3 may result from an overmoulding type process in which a first material 14 is moulded in a first mould 101 having a first geometry defining a first internal form and having a moulding cavity 108 corresponding to the shape and dimensions of a first element to be moulded. The moulded first material may be allowed to cool and solidify before a first element is extracted from the first mould 101. It may then be placed in a second mould 101 having a second internal geometry with a second internal form and with a second cavity 114. The second internal form may correspond for example to the shape and dimensions of a housing 3 to be formed and incorporating the geometries of the first and the second elements, i.e. incorporating the geometries of both a shell 14 and a membrane 35 joined thereto. A second injection step may then be carried out in the second mould 101 in which the first element in its solidified state, is pre-positioned. The second injection step may take place using a second material in a melted, flowable state and with the second injection material at a temperature which will ensure that it bonds effectively with the pre-positioned first element, in particular with an internal surface thereof. In embodiments, either: said first material is a resilient thermoplastic material and said first element forms a shell 14 of said housing 3, and said second material is an elastomeric material and said second element forms a membrane layer 35 of said housing 3; or: said first material is an elastomeric material and said first element forms a membrane layer 35 of said housing 3 and said second material is a thermoplastic material and said second element forms a shell 14 of said housing 3. The moulded housing 3 may be extracted once it has sufficiently solidified. Thus, in embodiments, 2K overmoulding may be carried out using two moulds, wherein a first part, moulded in a first mould, is removed from the first mould and then placed as an insert into a second mould, whereafter a second injection step may take place. For example, in one example of an overmoulding type co-moulding process, the shell 14 resulting from a first injection step in a first mould may be removed from the first mould and placed, as an insert, into a second mould, prior to a second moulding step of a second material, i.e. of a membrane 35. Still by way of example, the moulded shell 14 may be pre-positioned in a second mould 101 having a second internal form, which accommodates the shell 14 in a first internal cavity 108 thereof and which second internal form defines a second internal cavity 114 which is defined partly by an internal surface of the shell 14. A membrane 35 of a barrier 5 can be moulded in a second moulding step by injection into the second internal cavity 114 of a second mould 101 having said second internal form. A housing 3 may thereby be produced comprising, or consisting of, a rigid plastics shell 14 layer co-moulded with a thermoplastic elastomeric material layer forming a membrane 35 of a barrier 5. The shell 14 layer may in particular be fused with said co-moulded membrane layer 35. In embodiments using two moulds, there may be a single moulding arrangement including a first and a second mould or there may be a first and a second moulding arrangement, each with its own first or second mould. A first moulding arrangement may be a first moulding machine. A second moulding arrangement may be a second moulding machine. A single moulding arrangement may be a single moulding machine.

Co-moulding may thereby be carried out in two injections steps using either a first and a second mould 101; or by using a single mould 101 in a first and a second configuration. In some embodiments, it may be advantageous to use a single mould 101 having two configurations. For example, this may allow the first moulded element to be kept at a higher temperature during the second injection step, which may ensure an improved bond or fusion at the material interface 123. As mentioned, a shell 14 may exhibit opposing major surfaces which may be an internal and an external surface. A membrane 35 may exhibit opposing major surfaces which may be an internally facing and an externally facing surface thereof. An interface 123 between a membrane 35 and a shell 14 may be defined by the contact, or interference, boundary between an externally facing surface of said membrane 35 and an internal surface of said shell 14. Further details of method steps are provided below in connection with FIGS. 12a-d, FIGS. 13a-d, and in connection with FIGS. 10a-c and FIGS. 11a-b.

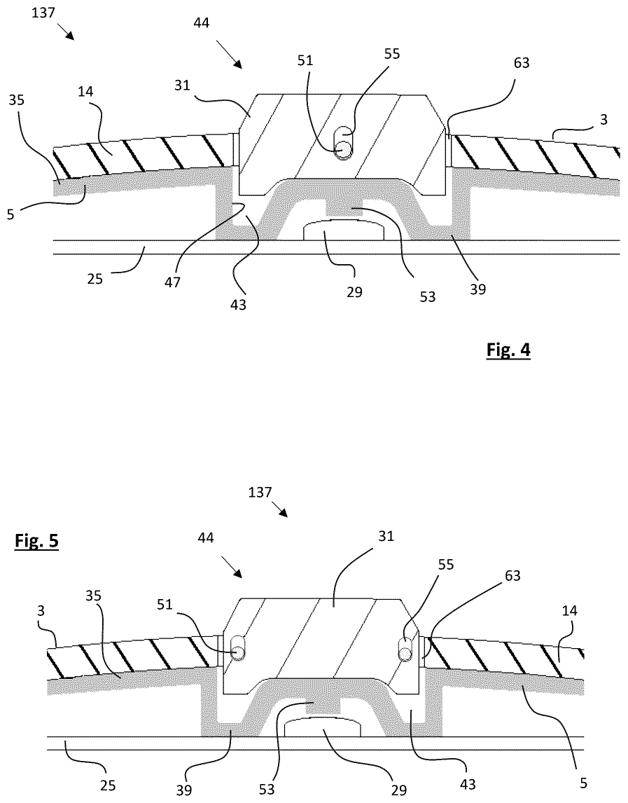

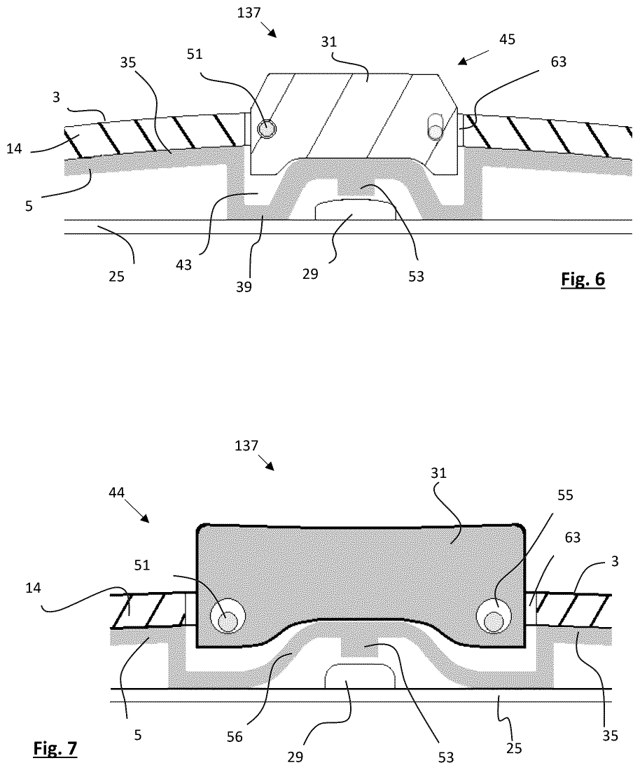

As may be better appreciated with reference to FIG. 4, a hearing aid 1 according to this disclosure may comprise a housing 3 which includes a shell layer 14 and a membrane layer 35 which forms a barrier 5 secured to the shell 14. As mentioned, the barrier 5 may be integral with the shell 14, preferably co-moulded therewith, preferably fused with an internal surface of the shell 14. The barrier 5 may be shaped to define a recess 43 at a said aperture 63. The recess 43 may comprise a side wall 47 and a floor 39. The membrane 35 thickness may be substantially even. The membrane 35 thickness may be substantially the same, both in the region of the recess 43, and in that region of the membrane 35 which is contiguous with the shell 14 internal surface. In embodiments, as shown in FIG. 4, an actuator 31 may be mounted to a shell 14 of a housing 3 using a single retaining pin 51 journalled in a pin hole 58 in the shell 14 and extending through a bore 55 in the body of the actuator 31. In the embodiment of FIG. 4, the actuator 31 may be a pusher 44. The bore 55 may be an oversized bore which may be slot-shaped. The dimensions of the oversized bore 55 and of the retaining pin 51 may be mutually selected to allow a translation movement of the pusher 44 in a direction perpendicular to the predominant plane of the housing 3 nearby the aperture 63, while at the same time preventing movement of the pusher 44 in a direction parallel to the said plane of the housing 3 and perpendicular to the retaining pin axis. The inner side wall 47 of the recess 43 preferably extends in a linear continuation of the inmost periphery of the aperture 63. This arrangement may be a result from the moulding process of the membrane 35. Advantageously, also illustrated in FIG. 4, in the region of the recess 43, the recess floor 39 may be contoured to conform to both said switch 29 and to said actuator 31. Preferably, the contours of said aperture floor 39 define a dome shape having a concavity 56 in an orientation opposite to a concavity defined by said recess 43. The dome shape is concave as seen from the interior side of the floor 39. In this way, the switch 29 may be accommodated in the dome domed shape of the recess floor 39 of the membrane 35 at the aperture 63. Optionally, the internally facing side of the recess floor 39 may comprise a boss 53. The boss 53 may be formed in the moulding process of the membrane 35. The boss 53 may ensure a better transmission of an action by a user operating the actuator 31 to actuate the switch 29. In alternative embodiments (not illustrated) a boss 53 may be formed on an externally facing side of the recess 43. In embodiments, an actuator 31 may be mounted at an aperture 63 by means of two retaining pins 51. Such an embodiment is illustrated at FIG. 5, FIG. 6 or FIG. 7. In this embodiment, there may be provided two retaining pins 51, each received in a bore 55 in the body of an actuator 31. A first retaining pin 51 may be received in a first bore 55 in the body of an actuator 31. A second retaining pin 51 may be received in a second bore 55 in the body of the actuator 31. By way of example, both the first and the second bore 55 may be oversized in relation to the first and second retaining pins 51, as shown in FIG. 5 or FIG. 7. Still by way of example, both the first and the second bore 55 may be oversized, providing a loose fit. In one such embodiment, the bores 55 through the body of an actuator may be generally cylindrical, as shown in FIG. 7. Such an embodiment may allow for an easy actuation of the actuator 31. In the case of a pusher 44, this may make it possible to operate the actuator by applying pressure on the pusher 44, without necessarily requiring a pushing action by a user to be especially aligned with a direction normal to a predominant plane of the housing 3 nearby the relevant aperture 63. Optionally, both the first and the second bore 55 may be slot-shaped or of a slot type as already described. Such an embodiment is illustrated in FIG. 5. Such an arrangement may provide increased stability of the actuator 31 against lateral movement in relation to the housing 3, and/or it may improve the pushing action, reducing any tendency for the actuator 31 to tilt. It may also reduce any tendency for accidental operation of the actuator 31. In a variant embodiment, there may be provided a two-pin solution for mounting an actuator 31 at an aperture 63, in which a first pin 51 is received in a first bore 55 which has a tolerance fit in relation to said first pin 51. Whereas a second pin 51 is received in a second bore 55 which second bore 55 is an oversized bore 55 in relation to the second retaining pin 51. Such an embodiment is illustrated in FIG. 6. In particular, a second bore 55 may be slot-shaped or of a slot type as already described, as illustrated in FIG. 6. An actuator 31 may be a hinge type actuator 45, an example of which is shown in FIG. 6. A hinge type actuator 45 may in particular be pivotable about a retaining pin 51 which is received in a bore 55 in the body of the actuator 31 at location offset from a centre axis or central plane bisecting the actuator.

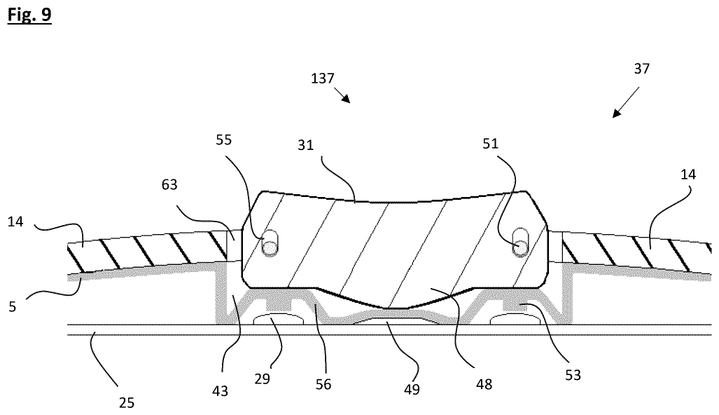

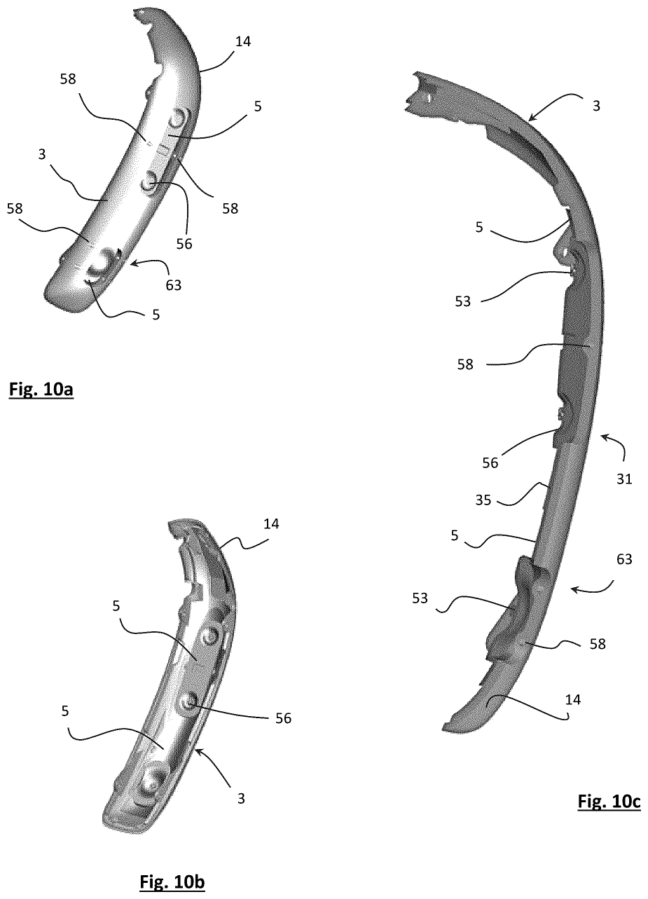

In embodiments, an actuator 31 may be provided in the form of a rocker 37. A rocker type actuator 31 may be associated with two switches 29 inside the housing 3, namely a first switch 29 and a second switch 29. These may be provided on a single chassis 25. As mentioned, a rocker 37 may typically, though not exclusively, be used for up or down output sound volume control of a hearing aid 1. A rocker 37 actuator 31 may be mounted pivotally at an aperture 63, as shown for example in FIG. 8 or FIG. 9. A rocker 37 may be mounted using a retaining pin 51, journalled in a shell 14 of a housing, 3 at an aperture 63. A retaining pin 57 may be received through a bore 55 in the body of a rocker 37. In embodiments, the bore 55 may be tolerance fitted in relation to the retaining pin 57. An example is shown in FIG. 8. Accordingly, the retaining pin 51 may provide a pivot axis for the rocker 37, when operated by a user, in one or other rotational direction. Still in connection with a rocker 37, and in particular with the operation of two switches 29, the floor 39 of a recess 43 in a membrane 35 may be configured with two dome shaped regions, with a first concavity 56 and a second concavity 56, each facing inwards toward the inside of the housing 3. A first switch 29 and a second switch 29 may each be encompassed within a respective domed region, or concavity 56 on the floor of the recess 43 of an aperture 63. Each concavity 56 may be provided with a boss 53, as described in relation to other embodiments. In an alternative embodiment, the pivot action of an actuator 31 such as a rocker 37 may be assured by providing the body of the actuator 31 with a fulcrum 48. An example is shown in FIG. 9. This may take the form of a convex underside of the body of an actuator 37. The fulcrum 48 may act against a reaction plate 49 inside the housing 3. For example, a reaction plate 49 may be provided in the form of a portion of a chassis 25, in particular between two relevant switches 29 associated with a given rocker 37. For example, a reaction plate 49 may be provided in the form of a raised portion of a chassis 25. Therefore, in embodiments, there may be provided a hearing aid 1, wherein said actuator 31 is a rocker type 37, and wherein said actuator 31 comprises a medial fulcrum 48 on an inward facing side thereof, said fulcrum 48 acting against a floor 39 of a recess 43 of a membrane 35 of a barrier, which membrane 35 is backed by a countersurface within said hearing aid housing 3, which countersurface may be a reaction plate 48.

In aspects, there may be provided a method of manufacturing a hearing aid housing 3 configured for a hearing aid 1 per any aspects of this disclosure. The method may include the steps of:
providing a mould 101 having a first internal form and a first internal cavity 108; creating a housing shell 14 in a resilient plastics material, e.g. a thermoplastics material 14, by an injection moulding step in said first internal cavity 108. The housing shell 14 in particular may comprise opposing interior and exterior major surfaces. The shell 14 further comprises an aperture 63. The method further includes providing a mould 101 having a second internal form with a second internal cavity 114 and which second internal form includes portions defined by said housing shell 14; creating a membrane 35 in an elastomeric plastics material, preferably a thermoplastic elastomeric material, in said second internal cavity 114 by a second injection moulding step, to thereby generate a co-moulded housing 3 of said hearing aid 1. The mould 101 to be used may be a single mould 101 having a first and a second configuration with a respective first and second internal form. The housing 3 may comprise a housing shell 14 and a moulded membrane 35 which is integral with said shell 14. In particular, said shell 14 may thereby comprise a barrier 5 integral therewith and therefore also integral to the relevant housing 3. The membrane 35 may thus define a barrier 5, in particular a continuous, preferably flexible, contamination-proof, barrier 5 across said aperture 63 between the housing interior and the housing exterior. In embodiments, the membrane 35 may define a layer of a said barrier 5. The method of manufacturing a hearing aid housing 3 preferably further includes assembling an actuator 31 on the housing shell 14 by inserting said actuator 31 into said aperture 63 from an external region of said shell 14, i.e. from an external region of said housing 3. Inserting or removing a said actuator 31 from without the housing 3 leaves the membrane 35, and thereby the barrier 5, intact or undisturbed. In addition, in embodiments, the method may include inserting one or more pins 51 through said shell 14 and through a said actuator 31 thereby to mount said actuator 31 on a said housing 3, and thereby to retain said actuator 31 in said aperture 63.

In alternative aspects, a method of manufacturing a hearing aid housing 3 configured for a hearing aid 1 per any aspects of this disclosure may include the steps of: providing a mould 101 having a first internal cavity 108 defined by a first internal form; injection moulding a membrane 35 in an elastomeric plastics material in said first internal cavity 108; said membrane 35 defining an interior facing surface and an opposite, exterior facing surface thereof. The membrane 35 preferably comprises a recess 43. The method further includes providing a mould 101 having a second internal cavity 114 defined by a second internal form and which second internal form includes said membrane 35; and injection moulding a shell 14 of said housing 3 in a resilient plastics material in said second internal cavity 114 of said mould 101 by injection of said plastics material; said shell 14 defining an internal and an external surface thereof and comprising an aperture 63. Preferably, said aperture 63 is in correspondence with said recess 43. The method thereby generates a housing 3 comprising said shell 14 co-moulded together with said membrane 35. The housing 3 thereby comprises a membrane 35 integral with said shell 14, which membrane 35 defines a barrier 5, in particular a continuous barrier 5 across said aperture 63 between the housing interior and the housing exterior. The mould 101 to be used may be a single mould 101 having a first and a second configuration with a respective first and second internal form. The method preferably further includes assembling an actuator 31 on the housing 3 by inserting the actuator 31 into the aperture 63 from an external region of the housing 3. The method preferably further includes inserting one or more pins through the shell 14 and through the actuator 31. The actuator 31 is thereby mounted on the housing 3 and retained in the aperture 63.

In relation to any method aspects set forth herein, the mould 101 to be used may be a single mould 101 having a first and a second configuration with a respective first and second internal form; or alternatively, it may comprise using two moulds: a first mould 101 having a first internal geometry and a first internal form, and second mould 101 having a second internal geometry and a second internal form. Various moulding arrangements are set forth in more detail herein.

An exemplary moulding process is discussed more fully below and with reference to FIGS. 12a-d, FIGS. 13a-d, FIG. 10-c or FIGS. 11a-b, although the method may be relevant to any or all examples put forth herein. As shown in e.g. FIG. 1d or FIGS. 10a-c or FIGS. 11a-b, a shell 14 of a housing 3 may exhibit an internal and an external surface, corresponding to an interior and an exterior of a hearing aid 1, when the housing 3 is assembled as such. The process may require a mould 101 having a first configuration (see FIGS. 12a-b or FIGS. 13a-b) and a second configuration (see FIGS. 12c-d or FIGS. 13c-d), each configuration having its own internal form. The internal form of a mould, or of a mould configuration, may encompass a geometry which defines a cavity and possibly also a filled cavity, i.e. a cavity which is occupied by an insert. The internal form of a mould may also be defined by elements such as cores, which may be retractable e.g. as between a first or a second configuration of a mould e.g. a core may be advanced in one configuration of a mould and retracted in another configuration of the mould. In particular, the process may require a single mould 101 whose internal geometry, i.e. its internal form can be varied between a first and a second configuration. This may be achieved for example by the use of retractable mould cores or alternative mould halves. E.g. with reference to FIGS. 12a-d or FIGS. 13a-d, in embodiments, this may be achieved using a mould 101, a first half 201 of which is movable, e.g. rotatable, between a first facing half 202 in a first configuration and a second facing half 203 in a second configuration, wherein the first and second facing halves 202, 203 may have a mutually different geometry. Each of the first or second facing halves 202, 203 may be associated with a respective, distinct injection nozzle (not shown). In this sense, the term “half” or “halves” is used figuratively, not quantitatively. In the example illustrated in FIGS. 12a-d or FIGS. 13a-d, these drawings may denote a mould 101 with two alternative configurations, each with its own internal form is illustrated by using a first mould half 201 of a mould 101 together with alternative complementary facing mould halves 202, 203. A single mould with multiple configurations e.g. a first and a second configuration may be referred to, or known as, a transfer cavity mould. For example, as shown in FIGS. 12a-d, in a first injection moulding step, a shell 14 of a housing 3 may be generated in a mould 101 having a first internal geometry corresponding to a first internal form with a first internal cavity 108. The first material, i.e. the shell material, may be as set forth herein. The first internal form may result from the use of a first mould half 201 and a first complementary, facing mould half 202. The second internal form may result from the use of a first mould half 201 and a second complementary, facing mould half 203. Alternatively, a first mould 101 having a first geometry may correspond to the illustrations in FIGS. 12a-b or FIGS. 13a-b. While a second mould 101 having a second internal geometry may correspond to the illustrations at FIGS. 12b-c or FIGS. 13c-d. With reference to e.g. FIGS. 12a-b, as mentioned, a shell 14 may be made by injection of a first material heated to state in which it is melted and flowable enough for a first injection step. After the first injection step, the plastic material may partially cool then harden, so it is no longer in a liquid, flowable state. A shell 14 of a housing 3 may thereby result from the first injection moulding step. Next, in a second injection moulding step—see FIG. 12c-d, a membrane 35 of a housing 3 may be generated in a mould 101 having a second internal geometry—or having a second configuration-corresponding to a second internal form having a second internal cavity 114. The membrane 35 may be made by injection of a second material in a flowable state, flowable enough for the injection step. The material, and properties thereof, of the membrane 35 may be of any type as set forth herein. In embodiments, this second material may advantageously be injected at a higher temperature than the melt temperature of the first material. This may improve bonding properties at an interface layer 123 of the first and second materials. After injection, the second plastics material may cure or cool and become solid so it is no longer in a liquid, flowable state. A membrane layer 35 of a barrier 5 of a hearing aid housing 3 may thereby result from the second injection moulding step. The first complementary facing mould half 202 may be retractable, and may be retracted (see arrow a in FIG. 12b) from the first mould half 201 after the first injection moulding step. After retraction of the first complementary facing mould half 202, there may be advanced a second complementary, facing mould half 203 thereby to generate a second internal form having a second internal cavity 114. Note that the second internal form may encompass the shell 14 produced in the first injection moulding step. The second internal cavity 114 of the second internal form may thereby comprise an internal surface of the shell 14. The space to be filled in the mould 101 by the second injection moulding step may correspond to a membrane 35. In other words, in this example, the second internal cavity 114 may correspond to the volume of a membrane 35 to be co-moulded with the shell 14. There may thus be provided a mould 101 having a second configuration and a second internal form defining a second internal cavity 114. This second internal form may correspond to a desired configuration of a housing 3 or housing segment 9, 11 namely, a shell 14 additionally including a membrane layer 35 of a barrier 5. To this end, both the first internal form and the second the second internal form of the mould 101 may exhibit a face which corresponds substantially to an externally facing surface of a shell 14 of a housing segment 9, 11, most particularly of a dorsal housing segment 9 of a housing shell 14. Thereafter, in a second injection moulding step, a softer, elastomeric, thermoplastic or thermosetting material in a flowable state may be injected into a second internal cavity 114 in the mould 101 which defines a membrane 35 of a barrier layer 5. When injected, this softer elastomeric material may fuse with the thermoplastic material of the shell 14 which is present in the mould 101. When removed from a mould 101 (see arrow c in FIG. 12d denoting opening of the mould 101 allowing removal of the co-moulded elements), the moulded housing 3 comprises a shell 14 integral with a membrane 35 of a barrier layer 5; or a barrier layer 5 in the form of a membrane 35. In alternative embodiments, a mould 101, in each of its respective configurations, may be encompassed in a single moulding arrangement. A moulding arrangement may thus include a retractable core or mould element, for the first mould configuration 201; 202 or for the second configuration 201; 203 or both. After extraction from the final moulding step, one or more actuators 31 may be mounted to the housing 3 from the external region of the housing 3 and without breaching the membrane 35, i.e. without breaching the barrier 5. In other words, an actuator 31 to be mounted at a recess 63 need not already be mounted in place at a housing shell 14 before the co-moulding step of a housing membrane 35. The temperature of the second material to be injected is preferably selected such that the interface temperature between the two materials ensures that these can melt and/or fuse together at the interface 123. This will ensure a strong, functional bond between them for the intended purpose. In embodiments, the second material may be injected at a temperature above a melt temperature of the first material already present in the second mould configuration. A housing shell 14 may be moulded in a hard, thermoplastic material. This shell 14 may thereby be formed in a resilient material. This shell 14 may be moulded to a shape and dimensions corresponding to a mould cavity 108 of a first internal form. A second, flowable material may then be injected into the second internal cavity 114 formed by the same mould 101 with a retracted or replaced core to create a second internal form. This might be a soft or elastomeric material such as a thermoplastic elastomer (TPE) or thermosetting elastomer (e.g. LSR), which would bind to the already injected shell material.

In other examples, as shown e.g. in FIGS. 13a-d, in a first injection moulding step, a membrane 35 of a barrier 5 may be generated in a mould 101 having a first configuration (FIGS. 13a-b) with a first internal form and a first internal cavity 108. A first material to be injected may be a membrane material as set forth herein. The first internal form may result from the use of a first mould half 201 and a first complementary, facing mould half 202. As mentioned, a membrane 35 may be made by injection of a first material in a state in which it is flowable enough for a first injection step. This may e.g. be a heated, e.g. molten, state of the first material or e.g. a liquid, pre-curing state of the first material. After the first injection step, the plastic material may partially cool and/or cure then harden, so it is no longer in a liquid, flowable state. A membrane 35 of a barrier 5 of a housing 3 may thereby result from the first injection moulding step. Next, in a second injection moulding step, a shell 14 of a housing 3 may be generated in a mould 101 having a second configuration, i.e. a second internal form having a second internal cavity 114. The second internal form may result from the use of a first mould half 201 and a second complementary, facing mould half 203. The shell 14 may be made by injection in a second injection step using a second material, heated such that it is in a flowable state, flowable enough for the injection step. The material, and properties thereof, of the shell 14 may be of any type as set forth herein. In embodiments, this second material may advantageously, optionally, be injected at a higher temperature than the melt temperature of the first material, notably where the first material is a thermoplastic material. This may provide good bonding properties at an interface layer 123 of the first and second materials. After injection, the second plastics material may cool and become solid so it is no longer in a liquid, flowable state. A shell layer 14 integral with a membrane 35 of a barrier 5 of a hearing aid housing 3 may thereby result from the second injection moulding step. The first complementary facing mould half 202 may be retractable, and may be retracted (see arrow a in FIG. 13b) from the first mould half 201 after the first injection moulding step. After retraction of the first complementary facing mould half 202, there may be advanced a second complementary, facing mould half 203 thereby to generate a second internal form with a second internal cavity 114. Note that the second internal form may encompass the membrane 35 produced in the first injection moulding step. Part of the geometry of the second internal cavity 114 of the second internal form may thereby be defined by an internal surface of the membrane 35. The space to be filled in the mould 101 by the second injection moulding step may correspond to a shell 14. In other words, in this example, the second internal cavity 114 may correspond to the volume of a shell 14 to be co-moulded with the membrane 35. There may thus be provided a mould 101 in a second configuration having a second internal form defining a second internal cavity 114. This second internal form may correspond to a desired configuration of a housing 3 or housing segment 9, 11 namely, a shell 14 additionally including a membrane layer of a barrier 5. To this end, the second internal form of the mould 101 may exhibit a face which corresponds substantially to an externally facing surface of a membrane 35 of a barrier 5 of a housing segment 9, 11, most particularly of a dorsal housing segment 9 of a housing shell 14. Thereafter, in a second injection moulding step, a more rigid, thermoplastic material in a heated, flowable state may be injected into a second internal cavity 114 in the mould 101 which defines a shell 14. When injected, this more rigid plastics material may fuse with the elastomeric material of the membrane 35 which is present in the mould 101. When removed from a mould 101 (see arrow c in FIG. 13d denoting opening of the mould 101 allowing removal of the co-moulded elements), the moulded housing 3 comprises a shell 14 fused to a membrane 35 of a barrier layer 5; or a barrier layer 5 in the form of a membrane 35. The temperature of the second, thermoplastic material to be injected is preferably selected such that the interface temperature between the two materials ensures that these can melt and/or fuse together at the interface 123. This may ensure a functional bond between them. In embodiments, the second material may be injected at a temperature above a melt temperature of the first material already present in the second mould configuration.

In embodiments, prior to a second injection step, a retractable core may be inserted into the second mould configuration, which core matches the shape of the aperture 63. The core may pass from an external side of the shell 14, through the aperture 63, to protrude slightly from an internal surface of the shell 14. In an injection moulding step of a membrane, a flowable, soft material of the membrane 35 may be injected into a space between the inserted core, the internal surface of the shell 14, and the opposite facing inside surface of the second mould cavity 114. This injection step will thereby generate a membrane layer 35 as a barrier layer 5 or as part of a barrier 5. The process apparatus may include the use of a first and a second injection unit, allowing a respective said first and second injection step, in particular, of a first and a second material.

In embodiments, one type of co-moulding may advantageously be implemented as an overmoulding process. Preferably, the process may be implemented as a so-called 2 k moulding process. Preferably, the two-step moulding process may be implemented in a single moulding machine, which may be a 2 k moulding machine. Preferably, the two-step moulding machine may be programmed to perform two injection cycles of two moulding materials into a single mould. Preferably, a second injection cycle is performed while the moulded part from the first injection cycle is still in the mould and still hot, i.e. in a solid state but not in its fully cooled state. In the case of a single mould 101 for more than one injection step, the mould's internal form is preferably changed after a first material injection step and prior to a second material injection step.

With reference to FIGS. 10a-c: A hearing aid housing 3 may comprise a shell layer 14 and a membrane layer 35. The membrane layer 35 may be co-moulded with the shell layer 14. A barrier layer 5 of a housing 3 may comprise, or may be comprised of, a membrane layer 35. A housing 3 may comprise an aperture 63. The aperture 63 may be formed in the shell layer 14 of the housing 3. An aperture 63 may be associated with a recess 43 formed by a membrane 35 at said aperture 63. A recess 43 may comprise a concavity 56 in a floor 39 of said recess 43, which concavity 56 is concave in respect of an internal major face of the membrane 35. A concavity may be provided in correspondence with a switch 29 within the hearing aid 1. An actuator, 31, mounted at a said aperture 63 may be retained in place using retaining pins 51 journalled in pin holes 58 in a shell 14 of the housing 3. Looking for example at FIG. 10c, a membrane 35 may extend across more than one aperture 63 and along the inside major surface of a shell 14. A membrane 35 may extend to cover more than half, or more than two thirds of the internal surface area of a shell 14. With reference to FIGS. 11a-b: A housing segment may comprise one or two or more than one or more than two in-built chassis 25. A chassis 25 may support internal components 27 of a hearing aid 1 including one or more switches 29. A housing segment 9 may comprise two or more apertures 63. A housing segment 9 may comprise one or two or more actuators 31. A housing segment 9 may comprise a rocker 37 and/or a pusher 44. Retaining pins 51 may be extractable from a housing segment 9, or shell 14, without requiring access to internal parts of a housing 3 or hearing aid 1. Retaining pins 51 may be extractable or replaceable without requiring opening of the hearing aid 1 or its housing 3. One or more or all an actuators 31 may be extractable or replaceable without requiring opening of the hearing aid 1 or its housing 3. A recess 43 at a membrane 35, which normally lies beneath an actuator 31, may be cleaned without requiring opening of the hearing aid 1 or its housing 3.

Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

In aspects, the hearing aid housing design is based on two-component injection moulding to ensure sealed push button actuators. The push button actuators combine a soft material such as TPE or LSR silicone for sealing, and stiffer plastic material (Youngs modulus above 1000 MPa) for the housing shell or for the push button actuator. The soft material is used as a sealing membrane in the shell to avoid ingress of sweat around the button. A sealed rocker button for 2 clicks and sealed floating button for single click were developed. The stiff material of the buttons can be decorated with paint. Painting may be carried out before the buttons are mounted. The buttons may be mounted using robust locking pins. Furthermore, the buttons can be serviced and replaced without removing the shell or opening the hearing aid, if needed.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. References to the barrier may be understood as references to a membrane of the barrier or to a membrane per se. References to a housing 3 may be understood as references to a housing segment thereof, i.e. to a portion of a housing 3 which housing 3 comprises more than one housing segment. A housing 3 may comprise a shell 14 and a barrier 5. A housing segment may comprise a shell 14 and a barrier 5. A barrier 5, when integral with a housing 3, may extend over all or part of the housing 3, in particular over all or part of an internal surface thereof, which internal surface may be an internal surface of a shell 14 of said housing 3 or housing segment. A barrier 5, though illustrated schematically herein as a single layer, may in fact comprise one or two or more layers. Where a barrier 5 is formed integral with a shell 14 of the housing 3, then at least one layer thereof is integral with the housing shell 14 of the housing. If a barrier 5 comprises more than one layer, than a membrane layer of the barrier 5 may in particular be integral with the shell 14. It will also be understood that when a part is referred to as being “connected” or “coupled” to another part, it can be directly connected or coupled to the other part, but an intervening part may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

The disclosure may alternatively or additionally relate to a hearing aid or method as defined in the following clauses. In an aspect of the present disclosure, there is provided a hearing aid as defined in appended clause 1. Further preferred features thereof are defined in clauses 2-23. A method of manufacturing a housing for such a hearing aid is defined in appended clause 24, further preferred method features are defined in clause 25. A method of manufacturing a housing for such a hearing aid is defined in appended clause 26, further preferred method features are defined in clause 27. Further, the present disclosure relates to a hearing aid housing as defined in any or all clauses 28-31.

Clause 1. A hearing aid (1) comprising:
a housing (3) defining an interior and an exterior of said hearing aid (1) and said housing (3); said housing (3) enclosing operative components (27) of said hearing aid (1), said housing (3) including an aperture (63) therethrough at a boundary between said interior and said exterior, said aperture (63) being in communication with said interior and said exterior;
a switch (29) associated with one or more said operative components (27);
a switch actuator (31) mounted on said housing (3) at said aperture (63), and operable by a user externally of said housing (3).

Clause 2. A hearing aid according to clause 1, said housing (3) further comprising a barrier (5) extending across said aperture (63) between the housing interior and the housing exterior, said barrier (5) being secured within said housing (3), preferably wherein said barrier being a barrier against passage of contaminants between the exterior and interior of said housing; preferably wherein said switch actuator (31) is arranged externally of said barrier (5).

Clause 3. A hearing aid according to clause 2, wherein said barrier is integral with said housing.

Clause 4. A hearing aid according to clause 2, wherein said barrier is continuous across said aperture.

Clause 5. A hearing aid according to any clause 2-4, wherein the material of said barrier is a flexible material, softer than the material of said housing, and wherein said barrier allows an operation action of the actuator to effect actuation of the associated switch.

Clause 6. A hearing aid according to any clause 2-5, wherein said barrier comprises a membrane which is co-moulded, preferably in a two-component moulding process, with a shell of said housing in a material which is flexible and softer than the material of said housing.

Clause 7. A hearing aid according to any preceding clause 2-6, wherein said barrier defines a recess at said aperture, said recess comprising a side wall and a floor; wherein said barrier is contoured to conform to both said switch and to said actuator; preferably wherein the contours of said aperture floor define a dome shape having a concavity in an orientation opposite to a concavity defined by said recess.

Clause 8. A hearing aid according to any preceding clause 2-7, wherein said barrier comprises a boss protruding and oriented internally into said housing, said boss being located on an internal face thereof and in correspondence with said switch; preferably wherein said boss drives a switching action of said switch when said actuator is operated e.g. by a user of said hearing aid.

Clause 9. A hearing aid according to any preceding clause, wherein said actuator is externally extractable from said aperture; in particular wherein said aperture and said actuator are each respectively dimensioned to allow free insertion of said actuator into said aperture.

Clause 10. A hearing aid according to any preceding clause, wherein said actuator is retained in said aperture by one or more externally extractable retaining pins journalled in said housing.

Clause 11. A hearing aid according to preceding clause 10, wherein each said retaining pin is received through a bore in a body of said actuator.

Clause 12. A hearing aid according to clause 11, wherein one or more said bore in said actuator body provides a loose fit about said retaining pin, said bore being relatively dimensioned to allow a translation motion of said actuator about one or more said retaining pin, said translation motion corresponding to a switching action operating said switch.

Clause 13. A hearing aid according to any clause 10-12, wherein said actuator is a pusher or a rocker retained in said aperture by two externally extractable pins journalled in said housing; or wherein said actuator is a pusher or a rocker retained in said aperture by a single externally extractable pin journalled in said housing.

Clause 14. A hearing aid according to clause 13, wherein said hearing aid comprises more than one said actuator mounted at said housing thereof; each said actuator being mounted in a corresponding said housing aperture, and in correspondence with a corresponding switch in said hearing aid.

Clause 15. A hearing aid according to any preceding clause, wherein all said operative components are free of PFAS coatings and/or free of PFAS; preferably wherein said hearing aid including all components is PFAS-free.

Clause 16. A hearing aid according to any preceding clause, wherein said housing includes a shell; preferably wherein said shell is in the form of a shell layer of said housing.

Clause 17. A hearing aid according to any preceding clause and clause 16, wherein said aperture is formed in said shell.

Clause 18. A hearing aid according to clause 17 wherein said actuator is mounted in said shell of said housing.

Clause 19. A hearing aid according to clause 18 and clause 10, wherein said retaining pins are journalled in a shell of said housing.

Clause 20. A hearing aid according to any preceding claim including clause 16 and clause 3, wherein said barrier is integral with said shell.

Clause 21. A hearing aid according to clause 20, wherein said barrier is co-moulded with a shell of said housing in a material which is flexible and softer than the material of said housing; preferably wherein said barrier is co-moulded with a shell of said housing in a two-component moulding process.

Clause 22. A hearing aid according to any preceding clause, wherein said housing includes a first housing segment and a second housing segment; optionally wherein said housing includes a third and/or fourth housing segments.

Clause 23. A hearing aid according to one or more preceding clause including clause 1, wherein said actuator is a rocker type, and wherein said actuator comprises a medial fulcrum on an inward facing side thereof, said fulcrum acting against said membrane floor, backed by a countersurface within said hearing aid housing.

Clause 24. Method of manufacturing a hearing aid housing configured for a hearing aid according to any preceding clause,
said method including the steps of:
providing a mould having a first internal form;
injection moulding a shell of said housing in a resilient plastics material in said first internal form, said shell defining an interior and an exterior thereof and comprising an aperture;
said method further including assembling an actuator on said housing shell by inserting said actuator into said aperture from an external region of said first housing shell;
said method preferably further including inserting one or more pins through said housing shell and through said actuator thereby to mount said actuator on said housing and thereby to retain said actuator in said aperture.

Clause 25. Method according to clause 24, further including, after said step of injection moulding a shell in said first internal form;
providing a mould having a second internal form and which second internal form includes an internal surface of said shell;
injection moulding an elastomeric plastics material in said second internal form to thereby generate a housing comprising said shell co-moulded together with said barrier, in particular with a membrane layer of said barrier; said barrier being integral with said shell of said housing; preferably wherein said barrier is fused together with an internal surface of said shell of said housing.

Clause 26. Method of manufacturing a hearing aid housing configured for a hearing aid according to any preceding clause,
said method including the steps of:
providing a mould having a first internal form;
injection moulding a membrane of a barrier of said housing in an elastomeric plastics material in said first internal form, said membrane defining an interior facing, and an opposite exterior facing surface thereof and comprising a recess;
said method further including providing a mould having a second internal form and which second internal form includes an exterior surface of said membrane;
injection moulding a shell of said housing in a resilient plastics material in said second internal form, said shell defining an interior and an exterior thereof and comprising an aperture at a said recess of said membrane;
thereby to generate a housing comprising said shell co-moulded together with said barrier, in particular with a membrane layer of said barrier; said barrier being integral with said shell of said housing; preferably wherein said barrier is fused together with an internal surface of said shell of said housing.

Clause 27. Method according to clause 26, further including, after said step of injection moulding a shell in said second internal form;
assembling an actuator on said housing shell by inserting said actuator into said aperture from an external region of said first housing shell;
said method preferably further including inserting one or more pins through said housing shell and through said actuator thereby to mount said actuator on said housing and thereby to retain said actuator in said aperture.

Clause 28. Hearing aid housing (3) including a switching assembly (137), said switching assembly (137) including an actuator (31) received within an aperture (63) in a shell (14) of said housing (3), said switching assembly (137) further including a barrier (5) extending across said aperture (63), wherein said actuator (31) is received within said aperture (63) on an external side of said barrier (5);
wherein said switching assembly (137) further comprises one or two retaining pins (51) associated with said actuator (31).

Clause 29. Hearing aid housing (3) including a switching assembly (137), said switching assembly (137) including an actuator (31) received within an aperture (63) in a shell (14) of said housing (3), said switching assembly (137) further including a barrier (5) extending across said aperture (63), wherein said actuator (31) is received within said aperture (63) on an external side of said barrier (5);

Clause 30. Hearing aid housing (3) according to clause 28 or 29, wherein said barrier (5) comprises a membrane (35), preferably wherein said membrane (35) is co-moulded together with said housing (3).

Clause 31. Hearing aid housing (3) according to clause 30, wherein said membrane (35) and said housing (3) together define a moisture-proof element extending between an interior region and an exterior region defined by said housing (3).

1. A hearing aid comprising:
a housing defining an interior and an exterior of said hearing aid; said housing enclosing operative components of said hearing aid, said housing including a shell with an internal surface and an external surface, and said housing having an aperture, said aperture defining a boundary between, and being in communication with, said interior and said exterior of said housing;
a switch associated with one or more said operative components;
a switch actuator mounted on said housing at said aperture, and operable by a user externally of said housing;
said housing further comprising a barrier extending across said aperture between said housing interior and said housing exterior, said barrier being secured in said housing at said internal surface, and wherein said barrier comprises a membrane.

2. A hearing aid according to claim 1, wherein said membrane is integral with said housing.

3. A hearing aid according to claim 1, wherein said barrier is continuous across said aperture

4. A hearing aid according to claim 1, wherein said barrier, comprises a flexible material, softer than the material of said housing, and wherein said barrier allows an operation action of the actuator to effect actuation of an associated switch.

5. A hearing aid according to claim 1, wherein said barrier is co-moulded with a shell of said housing, and wherein said membrane comprises a material which is flexible and softer than the material of said housing.

6. A hearing aid according to claim 1, wherein said barrier defines a recess at said aperture, said recess comprising a side wall and a floor; wherein said barrier is contoured to conform to both said switch and to said actuator.

7. A hearing aid according to claim 1, wherein the contours of said aperture floor define a dome shape having a concavity in an orientation opposite to a concavity defined by said recess.

8. A hearing aid according to claim 1, wherein said barrier comprises a boss protruding and oriented inward, internally into said housing, said boss being located on an internal face of said barrier and in correspondence with said switch.

9. A hearing aid according to claim 7, wherein said boss drives a switching action of said switch when said actuator is operated e.g. by a user of said hearing aid

10. A hearing aid according to claim 1, wherein said actuator is externally extractable from said aperture; in particular wherein said aperture and said actuator are each respectively dimensioned to allow free insertion, from an external region relative to said housing, of said actuator into said aperture.

11. A hearing aid according to claim 1, wherein said actuator is retained in said aperture by one or more externally extractable retaining pins journalled in said housing, in particular in a shell thereof.

12. A hearing aid according to claim 11, wherein each said retaining pin is received through a bore in a body of said actuator.

13. A hearing aid according to claim 12, wherein one or more said bore in said actuator body provides a loose fit about said retaining pin, said bore being relatively dimensioned to allow a translation motion of said actuator in relation to one or more said retaining pin, said translation motion corresponding to a switching action operating said switch.

14. A hearing aid according to claim 11, wherein said actuator is a pusher or a rocker retained in said aperture by two externally extractable pins journalled in said housing; or wherein said actuator is a pusher or a rocker retained in said aperture by a single externally extractable pin journalled in said housing.

15. A hearing aid according to claim 1, wherein said hearing aid comprises two or more said actuators mounted at said housing thereof; each said actuator being mounted at a corresponding said housing aperture, and in correspondence with a corresponding switch in said hearing aid.

16. A hearing aid according to claim 1, wherein all said operative components are free of PFAS coatings and/or free of PFAS.

17. A hearing aid according to claim 16, wherein said hearing aid including all parts and components thereof is PFAS-free.

18. Method of manufacturing a hearing aid housing configured for a hearing aid according to any preceding claim, said method including the steps of:
providing a mould having a first internal cavity defined by a first internal form;
injection moulding a first element in said first internal cavity of said mould by injection of a first plastics material therein; and
providing a mould having a second internal cavity defined by a second internal form and which second internal form includes said first element;
injection moulding a second element in said second internal cavity by injection of a second plastics material therein;
said first and second elements thereby being co-moulded together, and wherein either:
said first material is a resilient thermoplastic material and said first element forms a shell of said housing, and said second material is an elastomeric material and said second element forms a membrane layer of said housing;
or:
said first material is an elastomeric material and said first element forms a membrane layer of said housing and said second material is a thermoplastic material and said second element forms a shell of said housing;
wherein said shell defines an internal and an external surface thereof and comprises an aperture; said method thereby generating a housing comprising said shell co-moulded together with said membrane, said housing thereby comprising a membrane integral with said shell;
said membrane defining a barrier, in particular a continuous barrier across said aperture between the housing interior and the housing exterior;
said method further including assembling an actuator on said housing by inserting said actuator into said aperture from an external region of said housing.

19. A method according to claim 18, the method further including inserting one or more pins through said shell of said housing and through said actuator thereby to mount said actuator on said housing and thereby to retain said actuator in said aperture.
